(19) United States
(12) Patent Application Publication
(10) Pub. No.: US 2004/0078341 A1
(43) Pub. Date: Apr. 22, 2004

(54) System and method for selling digital information online

(76) Inventor: Terril John Steichen, Fairfax, VA (US)

Correspondence Address: Terril J. Steichen, 9814 McLearen Court, Fairfax, VA, 22030, US

(21) Appl. No.: 10/683,847

(22) Filed: Oct. 11, 2003

Related U.S. Application Data
(60) Provisional application No. 60/418,587, filed on Oct. 15, 2002.

(51) Int. Cl. G06F 17/60

(52) U.S. Cl. 705/64

(57) ABSTRACT

An online system and method for providing information products such as news articles, photos, documents, etc., to remote clients that are users of the system. The system tailors the content and price of the product for different segments of the market. For example, a news provider can sell business articles to one segment of the market for once set of prices, and sports articles to the same or another segment of the market for a different set of prices. Further, the system provides a means for delivering real time account information to the clients so that each client can know the exact status of his account, even as the client is ordering the content.

The system streamlines the entire online order processing and charge processing tasks to minimize the administrative interaction required of the client, thus simplifying and expediting the response and making the system more user-friendly. The inventive system has singular application for ordering and processing information content that is relatively low in unit price, that may have a high volume of requests, and that has to be processed in a minimum amount of time. The system may also apply different prices for the same content to different clients, dependent on factors such as subscription plan membership and usage volume. Still further, the system provides a means for assuring that the provider that the client has sufficient funds in its account to pay for the requested content, even before the content is delivered to the client.

This application claims the priority filing date of provisional patent application Serial No. 60/418,587 filed on Oct. 15, 2002 in the name of Terril J. Steichen, also the sole inventor of the present invention

### BACKGROUND OF THE INVENTION

The present invention pertains to an electronic information distribution system for providing a wide range of proprietary information simultaneously to different groups of consumers under a potentially wide set of group-specific payment options. As used herein, the term content refers to any form of digital information, including but not limited to files (text, audio, video of all formats), media streams, executable programs, and all forms of dynamically generated information responses to queries. Content may be in standard or streaming formats.

Existing systems that offer content online for payment are typically implemented either as a conventional subscription system, as a metered usage system, or as a pay-per-view system. None of these models is new, and all have a poor history of successful adoption, particularly on any significant scale.

A commonly cited reason for this lackluster record is the availability of the content elsewhere for free. Certainly, it is hard-to-impossible to compete effectively with ‘free’ equivalent content. That situation is gradually self-correcting as more ‘free’ content sites (which mostly means advertising-supported) either cease to operate, or themselves shift to a payment model.

However, this factor has tended to obscure the fact that there are several other key reasons that stem not so much from the market as from shortcomings of the current technology. It is to these technologically induced shortcomings that the present invention is directed. The most important of these factors are (1) the inability to structure and simultaneously offer a wide range of different content ‘packages’, and (2) the inability to effectively process requests in a manner that supports the streamlined mode of user interaction required for selling content.

Whether they charge a flat, usage-insensitive fee, or charge per item, most online content selling systems provide purchasers with a single content product at a single price. A single price will be too expensive for some segments of a market (and they won't buy it), just right for some, and a bargain for others (which means they'll buy it for less than they are willing to pay).

The successful sale of content products, like any other merchandising activity, requires a product with a price that is high enough to generate a profit, and that is sold to a market that is large enough to generate sufficient revenues. The unique characteristic of a content offering is that the more specific and unique it is, the more valuable it is, but to a smaller market. A broader offering, on the other hand, appeals to a larger market, but has a smaller average value.

Rather than offering all content in the same fashion, a better approach is to optimize content for better market penetration. A content optimizing solution allows different aggregations of the content to be packaged, priced and sold online independently.

To be most effective, such an environment must allow content elements to be split up into their component parts, each of which has associated with it a smaller charge than that associated with the whole content element. Instead of selling a book as a single high-value sale, a content optimizing system may offer subscribers access to the books content on a chapter-by-chapter, page-by-page or even paragraph-by-paragraph basis. Suppose a book is priced at $30; a chapter might be priced at $5, a page at $0.50 and a paragraph at $0.20. A newspaper sold for a unit price of $0.25 might have its sports component available for $0.10 and it's comics for $0.05.

Currently, nearly all the items sold online are hard goods, most of which are obtainable from multiple sources; so competitive pricing is the norm. For most currently offered information products, there exists no alternative source of similar online products to use as a gauge, so prices are set arbitrarily. As more fee-based content becomes available, online pricing will have to become much more competitive. That means that vendors will have to pay a lot more attention to the financial transaction overhead build into offered prices, overhead, which, for information products can exceed of the actual charge.

Very few subscription systems offer the capability to package content; moreover, virtually none permit any significant level of optimization of price. Under conventional subscription systems, users pay a flat fee to access content for an associated period without incurring any additional (usage) charges. These types of systems are relatively easy to implement and maintain, but they provide very limited flexibility to discriminate between plans on the basis of price. All content elements are equally available, even though they may differ substantially in value. High and low volume users are charged exactly the same price.

Somewhat better pricing discrimination is available through pay-per-view systems. A pay-per-view system refers to a system that applies standard e-commerce payment mechanisms to the sale of information content. Under this form of payment, after selecting an item of content, a user makes an explicit decision to purchase and provides billing information (or authorizes the use of previously stored billing information). After the transaction has been approved, the purchaser is provided with a download url/password that may be employed (with several additional steps) to obtain a copy of the purchased material. This process, however, requires too many steps and takes too long to be viable for online publishing. And, as with a subscription system, high and low volume users are charge exactly the same price.

So-called micropayment systems offer the ability to process smaller (under $10) transactions with reasonable efficiency. But integrating an online content site with these systems still results in the same awkwardness and lack of speed as characterize regular pay-per-view systems. In addition, because no standard has yet emerged for such systems, vendors of online content that try to use one of today's micropayment systems must go through the substantial additional effort of getting their customers to register to use each system.

Better pricing discrimination can be achieved through metering systems. Such systems typically combine a flat fee with incremental usage-based charges. Metering systems automatically record user selections as purchases, deferring the detailed computation of charges and the actual charging/billing to a later time. While such systems require no extra steps and have a fast response, they too are unacceptable for online content selling because (a) since the charging is deliberately invisible, customers tend to reduce purchasing activity because of concern about charges accumulating to high levels without notice, and (b) because billing is deferred, vendors are faced with sometimes significant risks of non-payment.

Though pay-per-view and metering systems support the imposition of usage charges, both types of systems depend on background financial transactions to obtain payment. The manner in which the background financial transactions are conducted usually results in the very high transaction fees when a high volume of small individual usage charges exists.

What is needed is a system with the performance of a subscription system, the pricing precision of a pay-per-view system and the pricing flexibility of a metering system, but which overcomes the metering system drawbacks of high user anxiety and vendor non-payment risk. The present invention achieves these objectives.

A closer examination of metering systems will allow a better understanding of these drawbacks and what is required to overcome them. Metering systems (sometimes referred to as metered use systems) record events for later processing. Utility services (telephone, electricity, gas) are examples of metered services—usage is recorded and then accumulated along with other relevant details (such as time of day, person called, etc.) and later folded into a bill. Metering systems are not designed to make decisions about an action, merely to record the action.

Though such systems can record such data with a high degree of efficiency, experience has shown that for the process of selling online content and services, this very efficiency causes many if not most users anxiety. Customers worry that they may unintentionally cause charges to accumulate to unacceptable levels. As a result of this concern, use of metering for online systems has declined significantly. Nearly all of the prominent online services (AOL, Compuserve, Prodigy, Source, etc.) began as metered usage systems but have since migrated to flat use charging for just this reason.

As discussed earlier, the capability to set the price of content on the basis of usage (rather than under a simple flat fee structure) is critical. But these prices must be applied in ways that are much more sophisticated than simple metering systems, ways based not merely on recording events, but which also make critical real time decisions about those events. Users' worry about accumulating exorbitant metered usage charges would be largely alleviated if such systems provided users with the option of accepting or rejecting the pending charge. But to provide this capability, the system would have to be capable of making a decision—to deliver or not deliver content that it has already determined the requesting user is authorized to access, and that the requesting user has already selected.

A crude form of confirmation can be accomplished by merely inserting such a step in the request processing. (Ignore for the moment the fact that such a mechanism would seriously interfere with the smooth operation of the system—more on that later). However, for the option to confirm or reject the pending order to be meaningful, the user needs to at least be provided, at a minimum, with the amount of the charge they are being asked to accept.

In systems where all the purchased items have the same charge, determining the applicable charge in real time is simple, with little if any computation required. Similarly, in systems where all the users pay the same charge for a given item, computing the charge in real time is relatively simple.

But, in content optimizing systems as described earlier, each element of content may have a different base price, and different users may be given a different discount off that base. In such systems the task of computing the charge becomes much more difficult and more computationally intensive. Adding this kind of functionality to a metering system will tend to make the resultant system far more complex, costly and slow, for a given set of computational resources.

Moreover, a meaningful charge confirmation notice should inform the user not only of the amount of the pending charge, but also of the amount of that user's current accumulated charges. In order to have accurate knowledge of the state of the an account at all times, not only must all prior charges have been computed in real time, but the prior charges must have been added to the accumulated total as they occurred, without causing any significant degradation in the system's responsiveness and performance.

To do that, the system must have virtually instant access to the accumulated balance, and must be able to instantly update it with additional charges.

As alluded to above, it is not sufficient to provide a static confirmation mechanism, even when the notice provided by such a mechanism includes sufficient information to allow users to make informed choices. To prevent such a mechanism from becoming excessively disruptive to users, the mechanism should be capable of being selectively activated and de-activated by each user, with respect to that user's system interaction. Initially, when just beginning to use such a system, a user may wish the to confirm each purchase. But after becoming comfortable with using the system, some users may wish to de-activate the confirmation mechanism, so it ceases to generate confirmation notices, unless and until the user chooses to activate it again.

However, while user-controlled activation significantly improves the usefulness of the confirmation mechanism, the user is still required to guess as to whether that user's level of activity justifies the confirmation mechanism to be active or not. What is needed is a confirmation mechanism that is activated automatically by the system when and if either the pending charge, or the user's accumulated charge level exceeds user-specified thresholds. Such an automated confirmation mechanism would allow each individual user to optimize the balance between control and smooth operation.

The difficulties of effectively employing usage-based (that is, variable) charges are not limited to just the level of uncertainty it creates in users, and the effects of that uncertainty on usage levels. Variable charges also raise the probability that some users will be unable to pay bills that happen to be higher than expected. As a result, the vendor ends up with an increased risk of non-payment. What is needed is a system that can determine—prior to delivery of the requested content—whether the requesting client has sufficient financial resources to pay for the charge, and if not, deny the request.

As with implementing confirmation notice, implementing such an ‘ability-to-pay’ check also requires that the system compute the amount of an immediately pending charge in real time. And again, similar to the capability needed to implement the confirmation option, such a system must be able to also determine in real time if the user's account is sufficient to pay for the pending charge. Finally, if the user's balance is determined to be sufficient to cover a pending charge, the system must have the capability to deduct that charge from the users balance and add the charge to the user's total of accumulated charges.

To be able to make either of these types of decisions, a system must have access to account information for each user, including: (1) the balance that is available to pay for the content, and (2) the amount of cumulative charges that have been incurred. In addition, the system needs (3) the ability to adjust the available balance to reflect charges incurred by the user. Finally, the system needs to be able to perform all of these functions in real time, sub-second response time.

Most systems don't maintain account balances for their users. (One example of prior art, Qpass, does maintain user account balances; however, it does not provide real time access to these accounts, so does not differ from other metering systems from this perspective.) Instead, these systems require users to maintain balances to pay for charges with funds drawn from accounts users maintain with a credit card company or a bank. In the normal course of business involving such remote accounts, merchants submit transactions through a payment processing service, incurring a transaction fee for each submitted charge. If the account contains insufficient funds to cover the charge, the transaction will be refused. The whole process of submitting a charge and getting a response takes between 10 and 60 seconds or more, depending on the type of service connection available to the merchant.

Such remote accounts are unable to provide many of the essential capabilities required to support real time content merchandizing systems. These limitations include: (a) slow response time (by over an order of magnitude), (b) no service-specific balance maintained, (c) no service-specific accumulated charge amounts maintained, and (d) excessive transaction fees for small purchases.

Clearly, such remote accounts can't be used effectively to support the kind of real time charge processing required. What is required is for the system to maintain local account balances for its users. Unlike remote accounts, local accounts are (a) very fast to access, (b) specific to the services provided by the system, (c) can easily include accumulation totals and (d) are capable of aggregating many purchases into a single external transaction.

While local accounts are ideal (and essential) for handling real time transactions, they also need to periodically have funds deposited into them, in order to maintain balance levels capable of covering charges. Thus a system maintaining local accounts also needs (e) the capability of obtaining funds on behalf of users from external sources, but obtaining these funds need not necessarily be conducted in real time.

Therefore what is needed is a system with (1) local user accounts, (2) the capability to compute charges ‘on-the-fly’, and (3) the logic necessary to carry out these decisions. Metering systems not only fail to provide these critical capabilities, they also fail to provide other needed capabilities, including those for allowing:

(non-subscribing) visitors to pay for content

clients to share a single user identity in a way that allows them to pay usage charges

group subscription managers to limit the usage-based consumption by group members

tight integration of funding from external accounts when local balances become insufficient to cover pending charges;

package-specific volume discounts

application of usage credits (as well as charges) based on specific content and specific packages

clients to use a single request to both authenticate and specify requested content

Systems with the capability to successfully address these problems have failed to emerge for several reasons. One is that content is rarely offered in segmented packages, and thus fine-tuning of prices is not required. Another reason is a broad assumption that variable prices won't work. Yet another reason is the widespread practice of ‘outsourcing’ all payment processing to payment processing vendors (that is, providers of remote accounts). A final contributing factor is the practice of payment processing vendors of basing their businesses on providing vendor-neutral rather than vendor-specific services.

One example of the current state of the art is represented by the system described in U.S. Pat. No. 6,016,509 (“General Purpose Metering Mechanism for Distribution of Electronic Information”). This system provides a means for serving content from distributed publishers under a payment system. It differs from the present invention in that it provides no means for organizing content into separately priced packages, and that it handles only simple pricing structures, since all content is accessible to all users, and all users pay the same price for the same content.

Another example of prior art is represented by a very different kind of system called ‘eRights’. While the eRights system does provide a mechanism for organizing content into independently priced packages, it provides only a basic metering capability for handling the charge processing. As such, eRights exhibits the shortcomings discussed above pertaining to metering systems in general.

As mentioned earlier, one of the drawbacks of conventional subscription systems is that they usually offer visitors only one level of ‘premium content’ offerings. A non-subscriber is thus faced with the option of remaining a visitor, or becoming a full subscriber. There's usually no intermediate option.

Vendors have attempted to use trial subscriptions to address this problem. Unfortunately, trial subscriptions typically apply for a period that is too short for visitors to assimilate and understand how useful they will find the offering in the long term. (To extend trial periods significantly longer, however, vendors run the risk of subscribers bypassing the payment system in favor of using the free trial option instead.) Moreover, most trial subscription offers require the participants to provide credit/debit account information such that, unless the participant specifically chooses not to participate, billing commences automatically at the end of the trial period. Many potentially interested customers are nonetheless resistant to making even this initial financial commitment.

A system based on the present invention can be configured to provide an unlimited number of graduated, intermediate options. Instead of having to choose between nothing and a full subscription, users may be offered plans that, for example, require no flat payment but provide increased discounts and some additional content. A whole range of such intermediate options may be structured to create a graduated set of incentives to migrate visitors toward full subscription in much smaller, less threatening steps.

The present invention provides a mechanism for automating this migration. Visitors may register for ‘higher level’ plans (many which don't impose any front-end financial obligation) and be granted membership automatically. Each plan may be structured to provide additional subscriber benefits (in return, for example, for additional subscriber information, such as e-mail addresses, home addresses, etc.). Certain plans may be optimized for low-volume users, while others target intermediate or high-volume users.

Some web-based applications are beginning to make use of authentication services, such as Microsoft's Passport service, AOL's ‘Magic Carpet’ service, and other emerging (mosly Kerberos-based) authentication services. Rather than requiring each web-based application to independently verify users' identity (authentication), the user presents credentials (usually in the form of name and password) once to an authentication server, which upon successful authentication then issues some form of ‘ticket’ or encoded authorization. Participating web-based applications, through prior arrangement with the provider of authentication service, reliably receive and use the encoded (and reusable) authorization to verify the users' identities. This allows the user to enter credentials once and then have multiple participating sites ‘reuse’ that authentication as needed without requiring the user to re-enter the credentials.

One problem with the prior art is that web-based applications typically have to be specifically designed to authenticate via a remote service (as opposed to performing authentication locally). Another problem is that web-based applications that designed to use authentication services usually restrict their users to a specific authentication service. A third problem is that the authentication service may be unavailable, perhaps through system failures, network failures or as a result of being subject to a denial-of-service attack. In such cases, users of such web-applications may be unable to gain access.

The present invention solves all three problems by providing (a) both local and remote authentication options, (b) access to multiple different authentication services, and (c) a fall-back local authentication for users when their selected authentication service is not available.

### SUMMARY OF THE INVENTION

A system (referred to hereinafter as ‘Web-Exec™’) for selling information products in which the content of the products may be tailored and priced according to the value perceived by different segments of the served market, and in which charge processing is streamlined to minimize interference with user interaction and to speed the response. Charges to customers may consist of a hybrid of fixed and variable costs, optionally subject to mutually agreed upon credit limits.

The foregoing features and advantages of the present invention will be apparent from the following more particular description of the invention. The accompanying drawings, listed herein below, are useful in explaining the present invention.

### DRAWINGS

FIG. 1 shows a high level overview of the environment wherein the present invention is employed;

FIG. 2 shows an overview of the present invention titled Web-Exec;

FIG. 3 shows the major components of Web-Exec;

FIG. 4a shows the main components of Web-Exec's request processor;

FIG. 4b shows a more detailed overview of the action module manager and the main action module types

FIG. 4c illustrates Web-Exec used as a front-end control mechanism;

FIG. 4d describes the details of how Web-Exec connects to other content sysems;

FIG. 5a shows the internal structure and core relationships of the key data objects;

FIG. 5b shows additional relationships between the key data objects;

FIG. 5c lists the main properties of each of the key data objects;

FIG. 6a illustrates the session manager processing logic;

FIG. 6b illustrates the initial request processing logic;

FIG. 7 shows the processing logic used to find matches to files and reports resources;

FIG. 8 shows the processing logic used to find matches to module resources;

FIG. 9 shows the access control logic;

FIG. 10 shows the processing associated with secure mode;

FIG. 11 shows the initial set of charge processing logic;

FIG. 12 shows the additional set of charge processing logic;

FIG. 13 depicts the logic used to provide user confirmation of transactions;

FIG. 14 shows the logic used to adjust the level of recorded purchases;

FIG. 15 shows how credits are processed;

FIG. 16 illustrates the process of executing and processing action modules;

FIG. 17 shows the login display logic (Login);

FIG. 18a illustrates the initial login authentication logic (LoginProc A);

FIG. 18b illustrates additional initial login logic and associated security checks (LoginProc);

FIG. 18c illustrates the portion of the login logic pertaining to concurrent users (LoginProc C);

FIG. 18d illustrates the final login logic and associated security checks (LoginProc D);

FIG. 19 shows the final login logic (LoginMessage);

FIG. 20 shows the logout logic (LogOut);

FIG. 21 depicts the process of denying resource access to a user (Deny);

FIG. 22 depicts the process of denying login access to a user whose account is disabled (Disabled);

FIG. 23 shows the logic of requesting additional credit to a user with deficiencies (GetCredit);

FIG. 24 illustrates how additional credit information is processed (CreditProc);

FIG. 25 shows the default display process (Welcome);

FIG. 26 depicts the logic implementing purchase confirmation/verification (Verify);

FIG. 27a describes the background process that checks for expired or old sessions;

FIG. 27b describes the background process that checks for expired or old sessions;

FIG. 28 illustrates the process that allows a user to change selected settings (UserStatus);

FIG. 29a describes the logic used to process a user password change request (ChgPwd);

FIG. 29b describes the logic used to process a user request to change plans (Register);

FIG. 30 shows denied access and expired session scenarios;

FIG. 31 shows a confirmed purchase scenario;

FIG. 32 shows a scenario requiring the user to obtain additional credit;

FIG. 33 shows a disabled account and login denial scenario;

FIG. 34 shows a ‘one-shot’ request scenario;

FIG. 35 shows a denied access based on an unpublished resource;

FIG. 36 describes an example using a newspaper as content;

FIG. 37 describes an example of products derived from a newspaper base; and,

FIG. 38 illustrates some of the market segmentation options.

### DESCRIPTION OF THE INVENTION

This description begins with a set of definitions and then proceeds to a high level description of the overall system operation and data object structure. Then the detailed operation of the core system is described, followed by a description of the operation of each of the core modules and background processes. A specific scenario is discussed at the end.

Definition of Concepts:

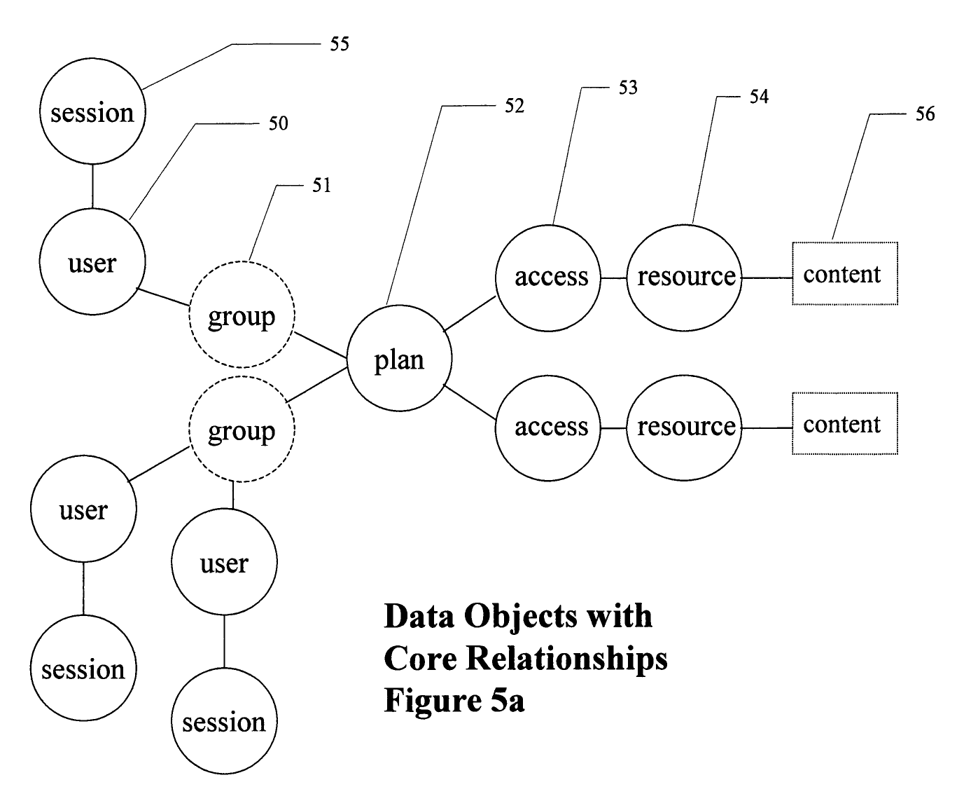

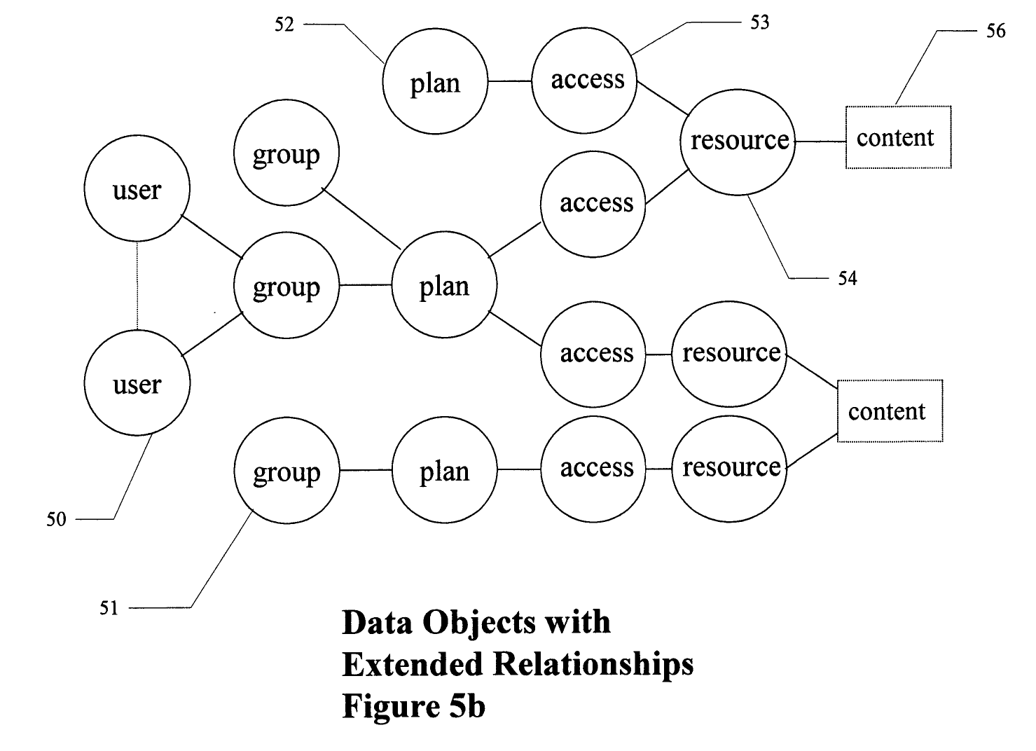

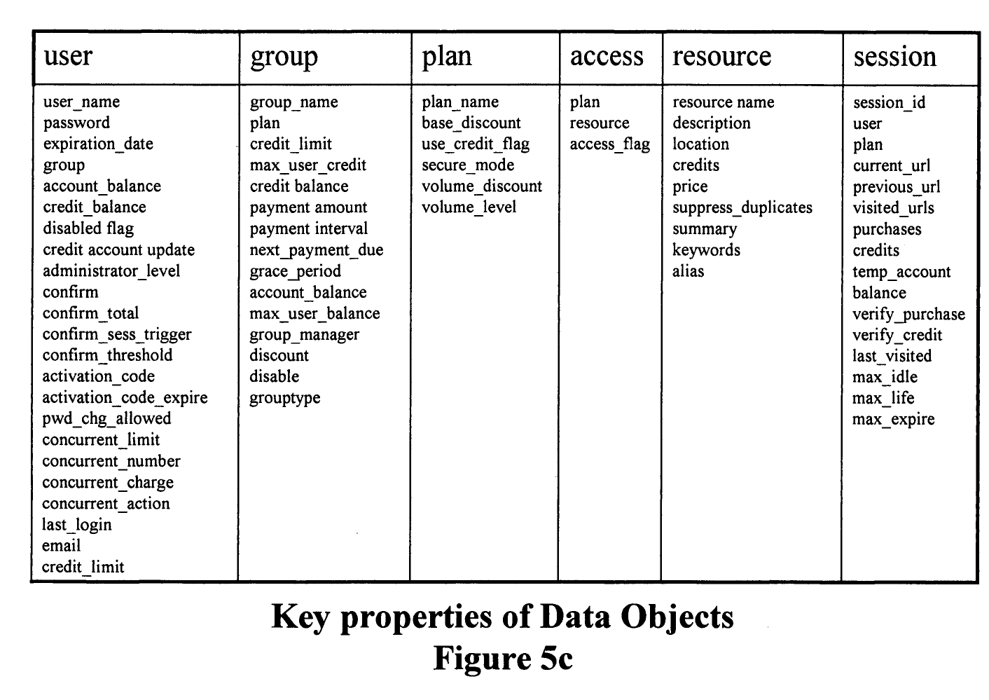

In order to more clearly describe the present invention, the following discussion of concept definitions is provided. All referenced data objects are described in FIG. 5a unless otherwise noted.

Information Content Element: An information content element is a concept that comprises an information product that can be electronically transmitted. Such products include file-based information (in standard or streaming formats) intended to be read (such as plain text files, HTML files, PDF files, etc.), to be heard (such as audio files, including music files), and to be viewed (such as graphic designs, images, video clips, etc.). Such products also include dynamically generated information (such as the results of a database query, the output of a graphing module, the output of a planning module, etc.) as well as other forms of information content. In the preferred embodiment, information content elements are specified in the ‘location’ property of the resource data object 54, FIG. 5a.

Subscription Plan: A subscription plan is a concept that specifies a set of information content elements that is made available to a specified set of subscribers under a specific set of charges and conditions. One of the main features of the present invention that differentiates it from prior art lies in its ability to offer content simultaneously under a variety of different services. The preferred embodiment implements the subscription plan concept through the linkage of group objects 51 with an associated subscription plan object 52. To simplify the diagrams, the subscription plan object is referred to as the plan object.

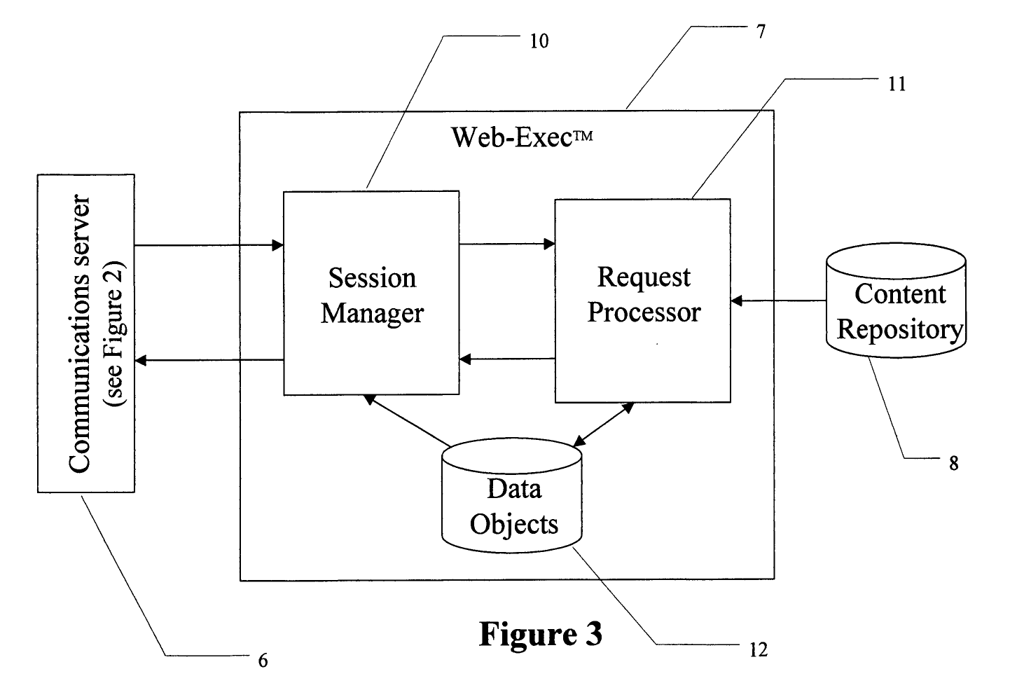

Subscriber: A subscriber of a subscription plan is concept that defines a client that is associated (by the actions of session manager, as shown in block 10 of FIG. 3, and as will be described in more detail herein below) with a user account (implemented as a user object 50 in the preferred embodiment) that has been defined and linked (through a group object) with subscription plan 52. Each subscriber has access to an account balance. The preferred embodiment implements the subscriber concept through the session object 55 and it's link to a user object 50, which is the preferred embodiment of the concept of a user account.

Session: A session is a concept that represents an association that has been created and is maintained by the session manager, between a client and a user account, such that the association persists over a period of time that may encompass multiple client requests. In the preferred embodiment, the session is implemented as a session object 50 whose properties include the ‘user’ property (which contains a reference to an associated user object). Each session also has properties relating to its time of creation as well as three specified intervals of time. If a session has existed for a specified interval of time (implemented the session's ‘max_life’ property), it is destroyed. A session whose client has not made any requests for a period of time (‘max_expire’ property) will shift into a suspended state. If the period of client inactivity continues for another period (‘max_idle’ property) the suspended session is destroyed. The purpose of the ‘max_expire’ property is to minimize the risk of unauthorized access while also minimizing the inconvenience to inactive subscribers who wish to continue with the established session.

Note that the underscore such as used above in ‘max_life’ property is a designation and not a typographical error. This designation will be used several times below.

Resource: A resource is a concept that defines one or more information content elements to which subscribers of a subscription plan are given access. A resource is also a convenient way to specify a price for the associated information content element or elements. That price may apply to all subscribers of all plans, or each plan may choose to waive it for its subscribers. For plans in which that price is not waived, the plan may adjust the level of the price. The resource concept is implemented by the preferred embodiment as a resource object 54 that is linked to the subscription plan object 52 through an access object 53, the latter providing the price waiver option.

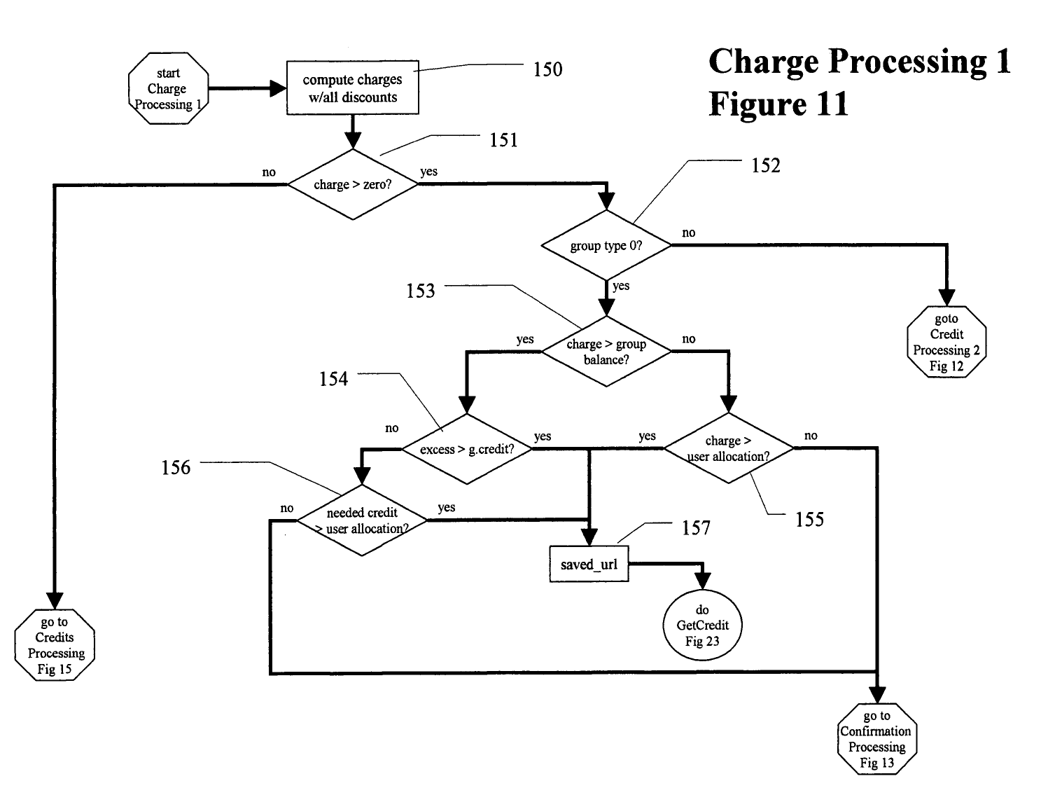

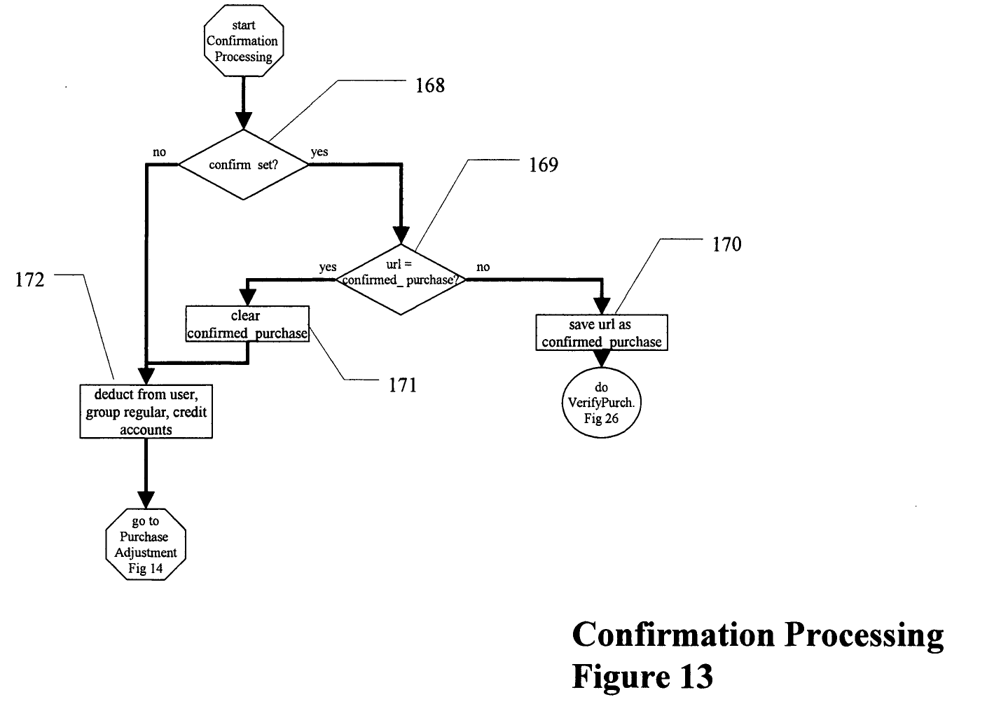

Access Condition: An access condition is a concept that comprises a specified action to be taken prior to delivery of a requested information content element after the request processor has determined that the requesting client has access to said requested content (by virtue of it being identified by a resource element associated with the subscription plan). These access conditions are applied after a real time computation of any pending charge that may apply once a subscriber receives a requested content element. In the preferred embodiment, the access conditions are implemented when and if such a charge exists, in two ways. The first condition, illustrated in FIG. 13, involves the process of obtaining the client's acceptance of the pending charge. The second involves a determination that the requesting client's account balance is sufficient to pay the pending charge and a subsequent adjustment to the requesting client's balance to reflect the imposition of that charge (FIGS. 11, 12 and 14). In the preferred embodiment, these access conditions may be applied individually or together.

A subscription plan may grant its subscribers access to content elements for which there is no matching resource. This feature allows the present invention to be used to control only a segment of available content, rather than all available content. In the preferred embodiment, this is implemented as the ‘secure_mode’ property of the subscription plan object shown in FIG. 5a.

Subscriber Account: A subscriber account balance may be persistent, in that it is maintained across multiple sessions (which, in the preferred embodiment, applies to subscribers who belong to either a type ‘0’ or type ‘1’ group), or it may be transient, having a lifetime limited to a session (which, in the preferred embodiment, applies to shared-identity subscribers, which belong to a type ‘2’ group). Subscribers with persistent account balances may be able to augment these balances with a shared group account balance (which, in the preferred embodiment, is the case if the subscriber belongs to a type ‘0’ group).

A persistent subscriber account balance may take the form of an ordinary debit balance, a credit balance or a hybrid debit/credit balance. The method of computing the available amount depends on the form of the account balance. In the preferred embodiment, the persistent individual account balances are implemented as user object properties as shown in FIG. 5a, block 50 (including the ‘balance’, and the ‘credit_balance’ and ‘credit_limit’ properties).

A transient subscriber account is implemented as a debit balance maintained through ‘temp_account’ property of the session object 50.

A group account is implemented in the preferred embodiment by a set of properties of the group object 51 (the ‘balance’, ‘credit_balance’ and ‘credit_limit’ properties), along with the ‘max_user_balance’ and ‘max_user_credit’ properties (to limit the amount of each group's debit and credit balance that can be consumed by an individual user).

Description Continues:

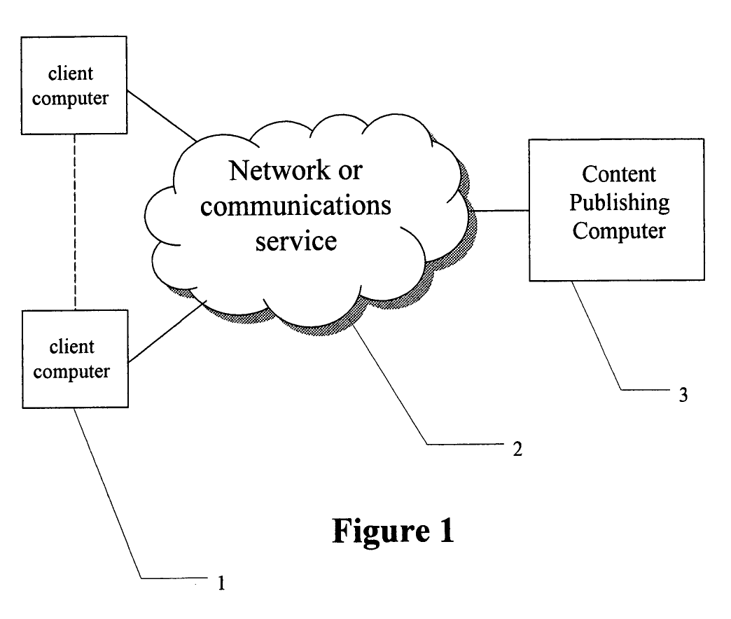

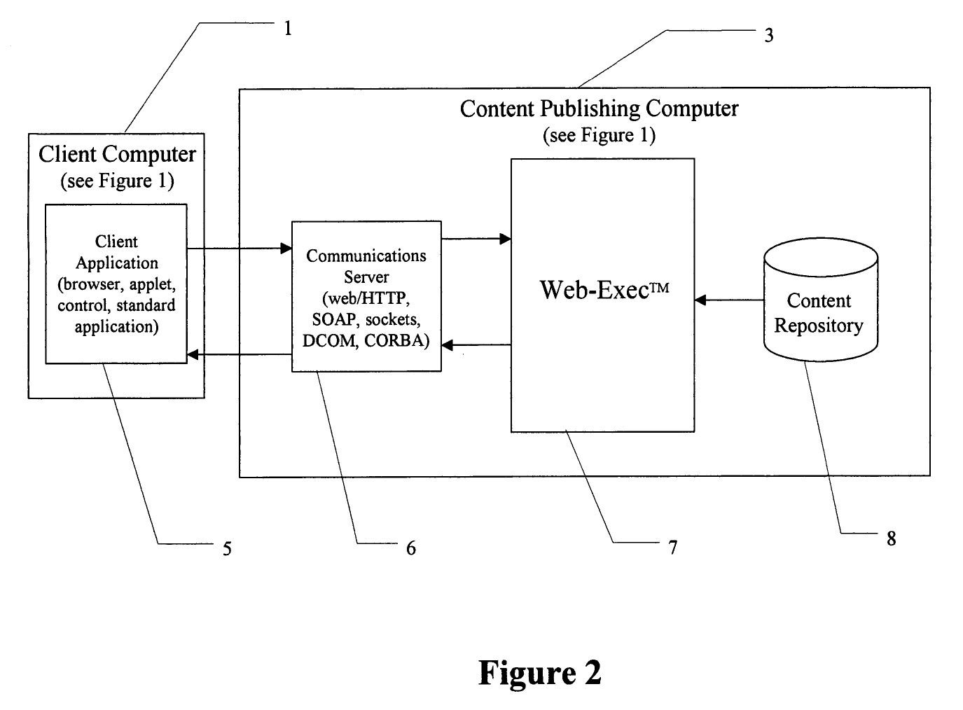

Returning now to the description, a high level illustration of the preferred embodiment of the present invention is show in FIG. 1. The system implementing the present invention is comprised of client computers 1 connected through a network 2 to a content publishing server 3. As shown in FIG. 2, within the client computer is a client application 5 that interacts with a communications server 6 that resides within the content publishing server. The communications server 6 interacts with the present invention, which takes the form of a software program called Web-Exec 7. Content requests are then satisfied by interaction between Web-Exec 7 and the content repository 8.

In the preferred embodiment, the client application 5 is implemented as a web browser or an application, the communications server 6 is implemented as a web (HTTP, or hypertext transport protocol) server or web services (SOAP, for Simplified Object Access Protocol) server, linked to Web-Exec 7 using a Java servlet interface. Besides being implemented as a browser application program, the client application 5 could take the form of non-browser application program or a small downloadable program such as a Java applet or Windows COM object. The communications server 6 could, besides using HTTP or SOAP, include remote procedure call applications (RPC), a sockets-based server, a CORBA (for Common Object Request Broker) server object, a Windows ‘DCOM’ server object, or a proprietary form of server. The interface between the communications server 6 and Web-Exec may alternatively employ CGI (Common Gateway Interface), ASP (Active Server Pages), CORBA, DCOM or a proprietary interface.

As shown in FIG. 3, within Web-Exec the requests are initially handled by the session manager 10, which then passes them to the request processor 11. Both the session manager 10 and the request processor 11 make use of a common set of data objects 12. (These data objects are described later in more detail in FIGS. 5a-5c.) The session manager ensures that the client making the request has been identified.

Most if not all prior art systems employ some form of a session management. Whatever its form, the central concept is a session, which generally refers to a sequence of interactions between a client and a server during which the client's identity is maintained. Typically, prior to a session being established, a client is required to provide credentials. Once the client is authenticated, a session is created. When the client logs out or when the client becomes inactive for a period of time, the session is terminated. The job of creating and terminating a session, as well as that of ensuring that each request is made by an authenticated client, are performed by some form of a session manager.

The present invention, like prior art, makes use of a session manager and sessions. However, the present invention substantially extends the functionality of the prior art session manager to support the key additional functionality described herein.

In the preferred embodiment, the session manager 10 creates a session object with a unique identifier for each initial request from each client, and to ensure that this identifier is henceforth associated with requests from this client during the period of current interaction. The preferred mechanism for associating this identifier with the user's request is through a ‘cookie’, with an automatic ‘fall-back’ to a technique of inserting the identifier into the request itself (known as url rewriting).

When the session manager 10 creates the session, it assigns a user identity to the session that, through its association with a subscription plan, defines the types of requests that will be honored for the client making the requests. As will be explained in more detail in subsequent descriptions, the system may be configured such that this identity is initially assigned as ‘anonymous’. If session manager determines that a request involves a user logging in or out of the system, or involves supplemental graphics files, the system will route the request directly to the action module manager 18.

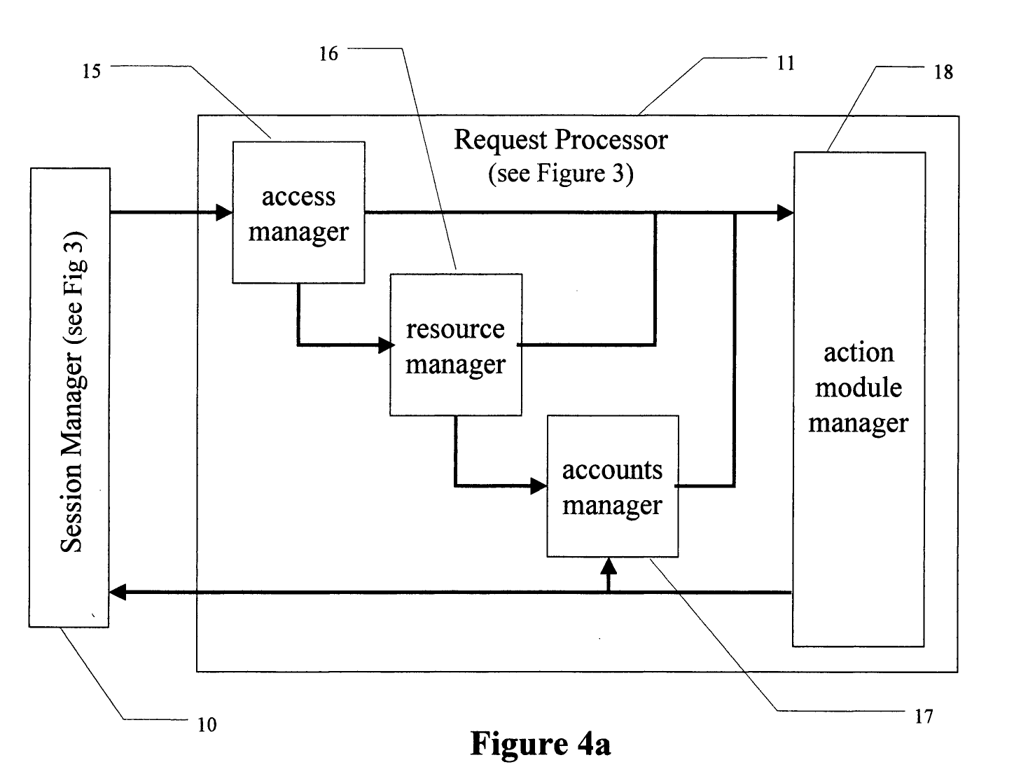

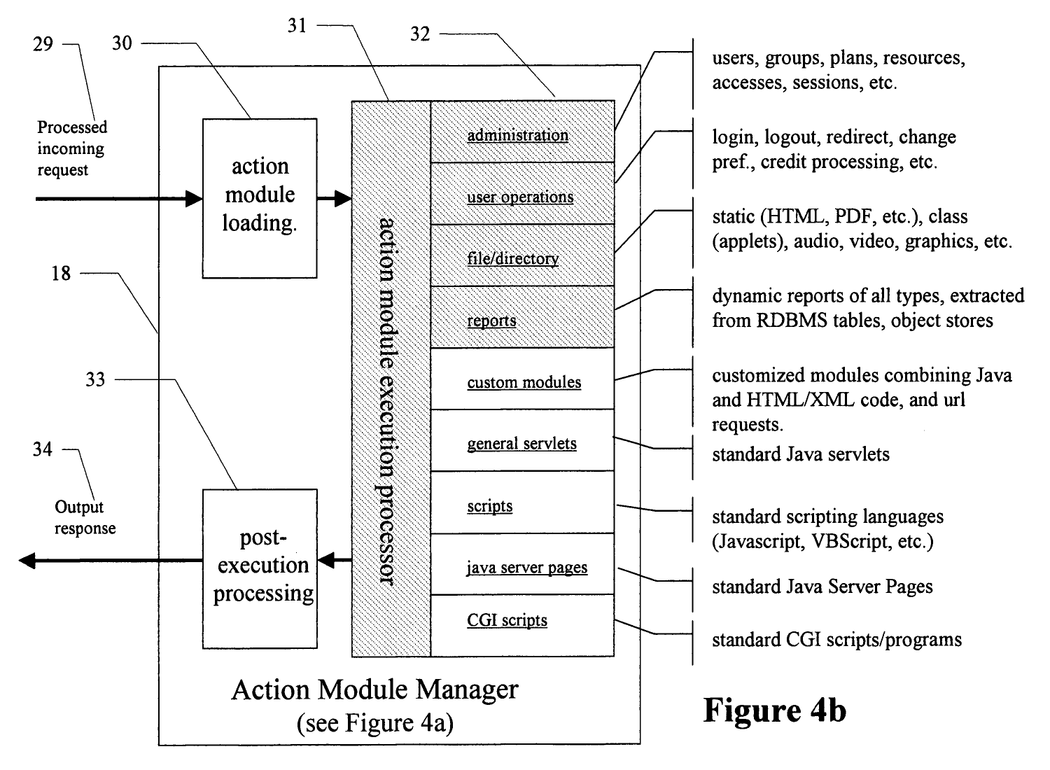

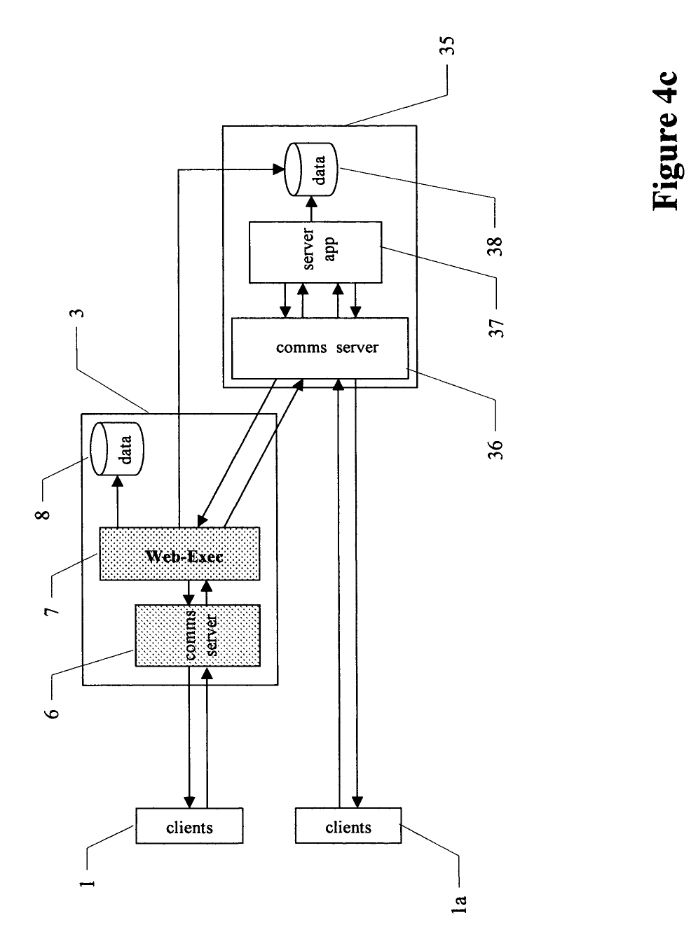

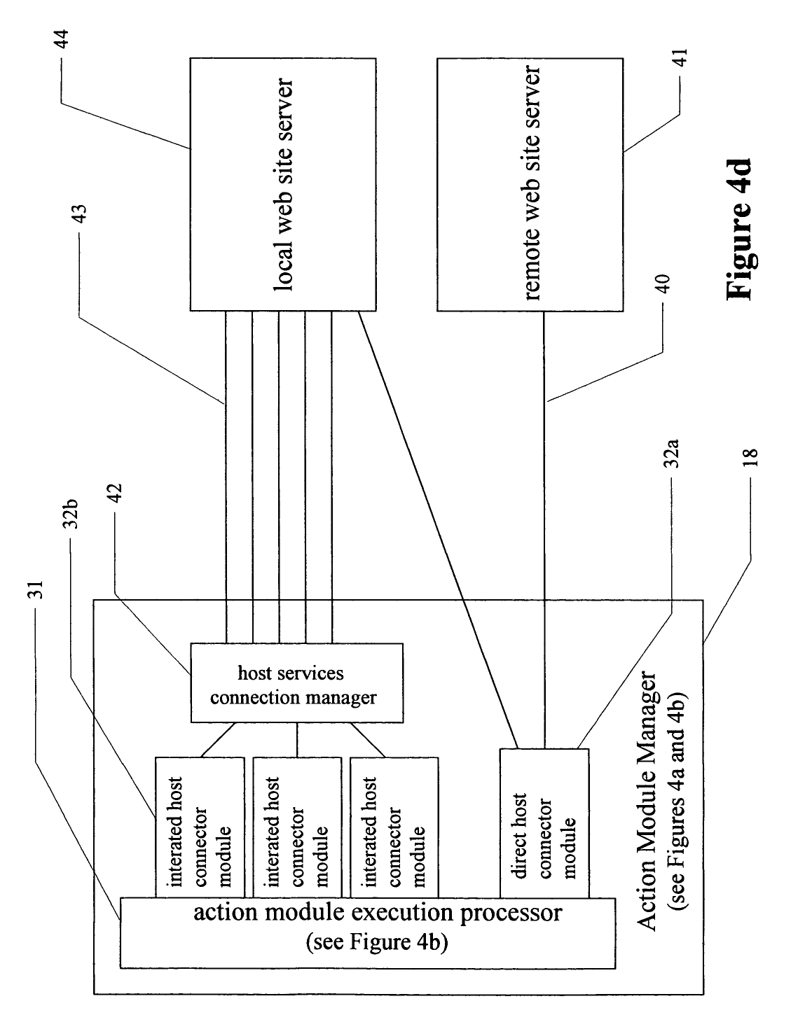

The request processor, as shown at block 11, FIG. 4a, contains four main components. The first is the access manager 15 whose job it is to ensure that the client making the request has been authorized to access the requested content. In some cases the client has been authorized unconditional access, in which case the request is passed directly to the action module manager 18. Otherwise, the resource manager 16 performs any translations required between the format of the request and that of the actual definition of the content itself. In cases where no charges are associated with the request, the processing proceeds directly to the action module manager 18.

When charges are involved, the accounts manager 17 determines the amount of the charge and makes any appropriate adjustments in the account balance being used by the client making the request.

The action module manager 18 then selects, loads and executes the action modules themselves. Once the action module has completed its processing, a response is normally forwarded back through the session manager. The only exception occurs when some specific post-processing event has occurred that requires an accounting adjustment, in which case the accounts manager 17 is also notified and makes any appropriate adjustments.

The components of the action module manager are shown in FIG. 4b. The incoming request 29 is used to select and load the appropriate action module, as shown in block 30. The action module execution processor 31 handles a wide range of different types of actions modules, as shown in block 32. When the selected and loaded action module has been executed, the next step is to conduct any required post-execution processing 33, after which the output response 34 is sent.

The shaded portion of FIG. 4b indicates the portion of the described modules that represent ‘core’ functionality—the unshaded ones are extensions (described below). Core functionality refers to functionality that is intrinsically part of the system, while non-core extensions provide value-adding additional functionality. Furthermore, as is shown in the diagram at block 32, there are several categories of action modules. While these modules are physically separate entities in the preferred embodiment, they may be also more deeply and invisibly embedded in the system.

As is well known in the art, objects that are employed in decision-making logic must have the means for administering them. Some action modules deal with administration these are typically accessible only to users with appropriate administrative access levels and are used to configure the system. Others action modules are used for operational purposes by all users—such as allowing users to login, logout, process credit, and so forth. Another type of action module provides the capability of serving directory and file-based information—this information can be of virtually any kind (text, audio, graphics, video, programs/applets). Another action module serves reports, typically generated from SQL queries. For purposes of clarity and conciseness in disclosure of the present invention, associated administrative modules will not be described in detail herein.

In addition, the system supports customized action modules and these can be in a wide range of forms including but not limited to custom Web-Exec™ modules, standard servlets, various forms of scripting language (such as—server-side—Javascript), Java Server Pages and CGI scripts.

Web-Exec can also manage, price and serve content that is hosted on other computers. As illustrated in FIG. 4c, the purpose of this is twofold. First, it allows Web-Exec to integrate content extracted from multiple remote servers with local content. Second, it allows Web-Exec to act as a ‘front end’ to provide full access control and pricing to an existing local web application, without requiring the content to be physically migrated from the existing machine.

Though the preferred embodiment as described herein is applied to online information content, the concept and features of the invention are applicable in generally to any system delivering services of any type.

FIG. 4c illustrates an existing, standard online system 35 interacting with one or more clients 1a. In this illustration Web-Exec 7 interacts with one or more different clients 1 through its own communications server 6. Web-Exec 7 may, depending on its configuration, serve the content from its own local data store 8, or from the existing site's data store 38. Alternatively or in addition to these sources, Web-Exec 7 may itself act as a client, placing content requests directly to the existing web site's server 36 which the existing web site's application 37 then satisfies, possibly by retrieving data from its own data store 38.

FIG. 4d illustrates in more detail the capability of the present invention to interact with existing web sites 35. Two different action modules (block 32 of FIG. 4b) are involved. The first is direct host connector module 32a which, when launched by the action module execution processor 31, connects to a remote web site server 41 using a standard host connection mechanism 40. The direct host connector module 32a makes a request to the remote web site server 41, receives that server's response, and passes it back to the action module execution processor 31.

The other web integration module is the integrated web connector module 32b. This action module, instead of interacting directly with the web site server 44, goes to the host services connection manager 42. The host services connection manager 42 starts up when Web-Exec itself begins and establishes multiple persistent connections 43 with a designated web site server 44, which usually resides in the network proximity of Web-Exec itself Multiple instances of the integrated host connector modules 32b can use the host services communications manager 42 simultaneously, providing very fast response from the local web site server 44 to which it is connected.

The main data objects used by the software, initially described in block 12 of FIG. 3, are described in more detail in FIG. 5a. In the preferred embodiment, each unique user of the system has an associated user object 50. The user object holds information that is unique to each user identity. In addition, multiple users may optionally share each user object. Each user object 50 is associated with a group object 51, which may be associated with multiple user objects. The purpose of the group object is to provide a means for associating multiple users with specific content through association with a subscription plan object 52. While the preferred embodiment uses a group object to aggregate users, it is recognized that a less sophisticated system might have the plan object directly aggregate users. The present invention employs the group object to support the key additional functionality described herein, It also allows such users to be managed collectively. Different group objects 51 may have an association with the same subscription plan object 52. The subscription plan object 52 defines the collection of resources that are available as well as conditions and prices associated with their use. To simplify the diagrams, the subscription plan object is referred to as the plan object. To define the desired set of accessible resources, each subscription plan object 52 may have any number of access objects 53 associated with it. The role of the access object 53 is to define complex permissions in terms of which resource objects 54 are allowed to be accessed and whether financial conditions should be applied as a condition for granting access. The resource object 54 contains the specific details needed to locate and retrieve the actual content 56— which can take any form—as well as definition of any credits that might be granted for those who retrieve this resource.

The session manager module (described earlier as block 10 in FIG. 3) creates the session object 55. Each session object contains a reference to the associated user object 50 as well as to the user's subscription plan object 52 associated with the group object 51 that is in turn associated with that user object 50. The purpose of the inclusion of the subscription plan reference in the session object is primarily to improve performance during the actual processing of each client request.

The relationships between these data objects can be much more complex, as shown in FIG. 5b. For example, this diagram shows that multiple group objects may be associated with a single plan object, that multiple access objects may reference a single resource object 54, and that a given content 56 may be referenced by multiple resource objects.

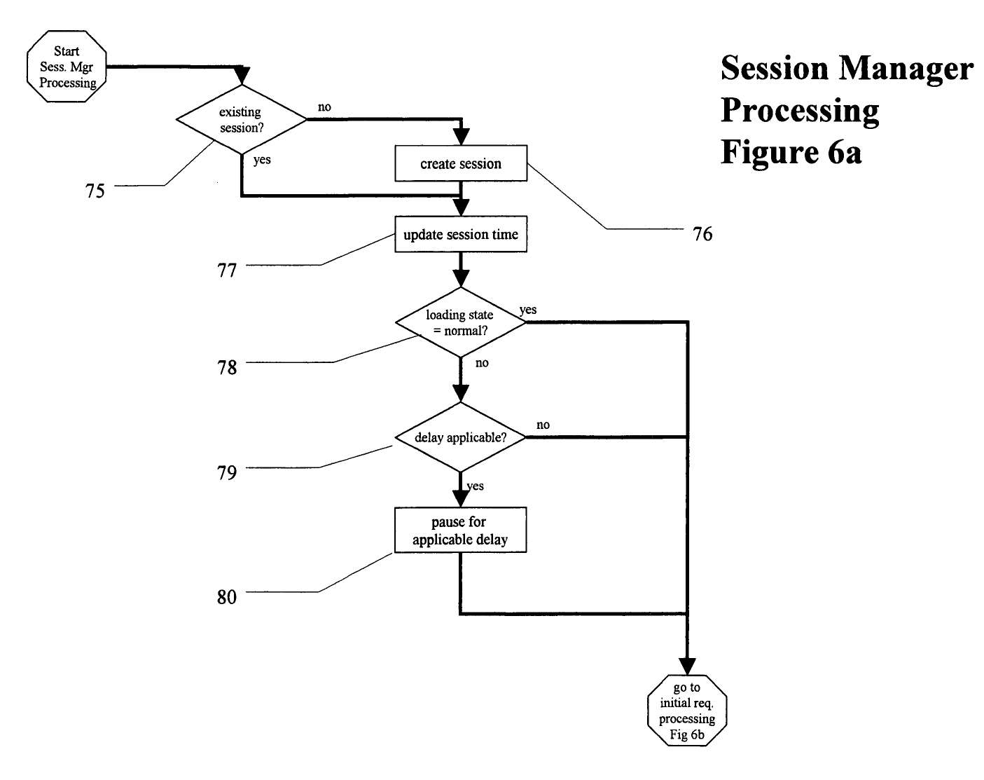

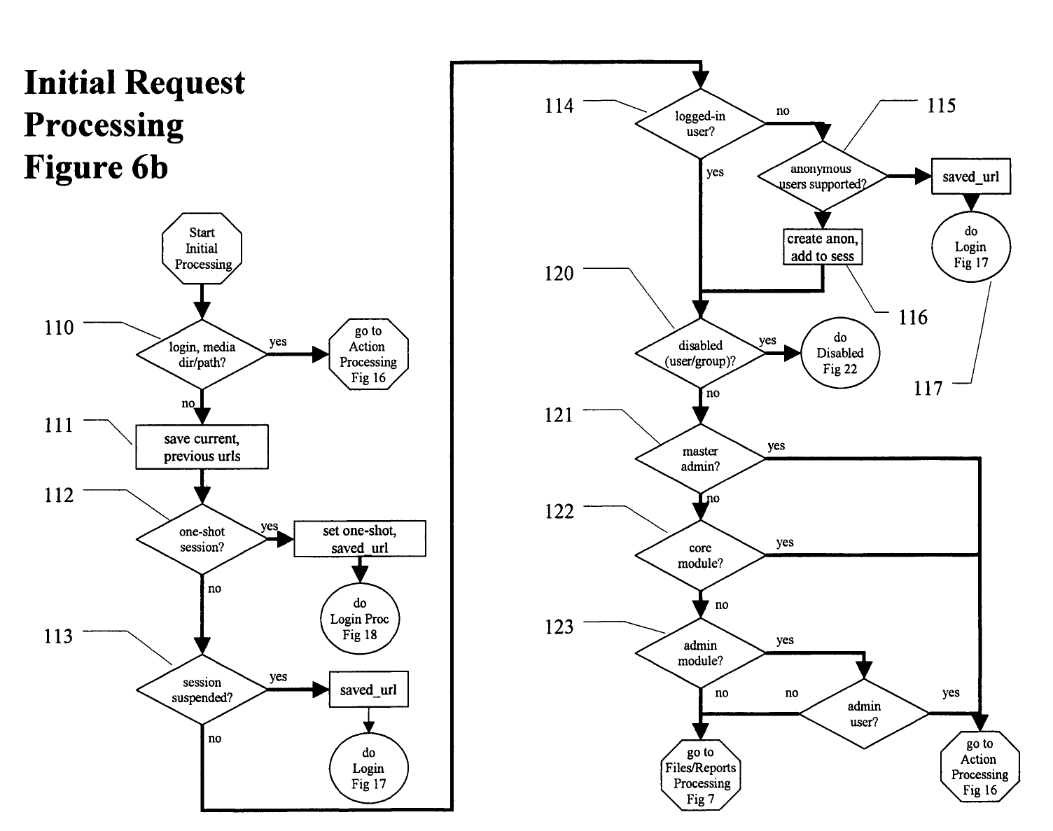

Each data object contains a set of properties as shown in FIG. 5c. These the value of these properties are used to define the states for each of the data objects as used in the request handling logic that is shown in more detail starting with the flow diagrams in FIG. 6a through FIG. 16.

In the preferred embodiment, the software uses a ‘request-response’ model of operation. In many instances, these diagrams depict an action of ‘do’ applied to some other target module. Block 117 of FIG. 6b illustrates an example of this action; in this case the software has determined a need to route the user to a login process. In the preferred embodiment, requests may be routed either by the server or through a technique that causes the client's browser to resubmit a new request to it reflecting to where the system chooses to route the user. In this example, the target module is the Login module, (which itself is further described in a subsequent figure). What happens in this case is that the request is replaced by a request for the target module, and the software causes this new request to be submitted by, or on behalf of, the client who made the original request. Note that in this case, the original request is first saved (in the session object). This is because the Login module (and other modules that it calls) knows how to handle such stored urls.

FIG. 6a illustrates the processing that occurs once a request is received from the communications server, shown previously at block 6 of FIG. 3. Initially, the system checks for the presence of an associated session object, shown at block 75 of FIG. 6a. In the preferred embodiment, the system creates a new session object if one does not already exist, as shown in block 76. At this point, the system updates the ‘last visited’ time property of the session object, block 77. This parameter, explained in more detail in a subsequent figure, is used by the system to determine when to suspend sessions and log associated users out.

The system then determines if the current level of loading (from simultaneous requests from multiple users) exceeds a defined threshold, block 78. If so, the system checks the throttle table (discussed below) to determine if one or more throttles are currently active and if so, whether they apply to the current request, block 79. If applicable, the processing pauses for the appropriate delay interval, block 80, after which processing continues with FIG. 6b. This feature allows the system to continue to provide a reasonable level of service to subscribers even in the face of a denial-of-service attack, or under some other form of excessive load.

The throttle level corresponds to an index into the throttle table, which is a configurable set of data that includes a throttle target definition and an associated delay. The throttle definition can be set to apply to a member of a specified group, previously referenced as block 51 of FIG. 5a, and/or on whether the request matches either the URL mask or the resource mask (as the properties ‘resource name’ and ‘description’, respectively) described in block 54 of FIG. 5a. The throttle number is the index of the throttle in the throttle table and its priority corresponds to its relative position in the throttle table. Throttles are applied in an escalating manner, starting with the first and moving up. At a given value of the ‘throttle level’, all throttles at that index or less are active.

As discussed in more detail in a subsequent figure, the system maintains two dynamic parameters to manage loading: the current system loading state, and the current throttle level. The former may have the values of ‘normal’, ‘better’, ‘worse’, or ‘same’. The latter is a numeric entry representing the relative position of the currently applicable throttle.

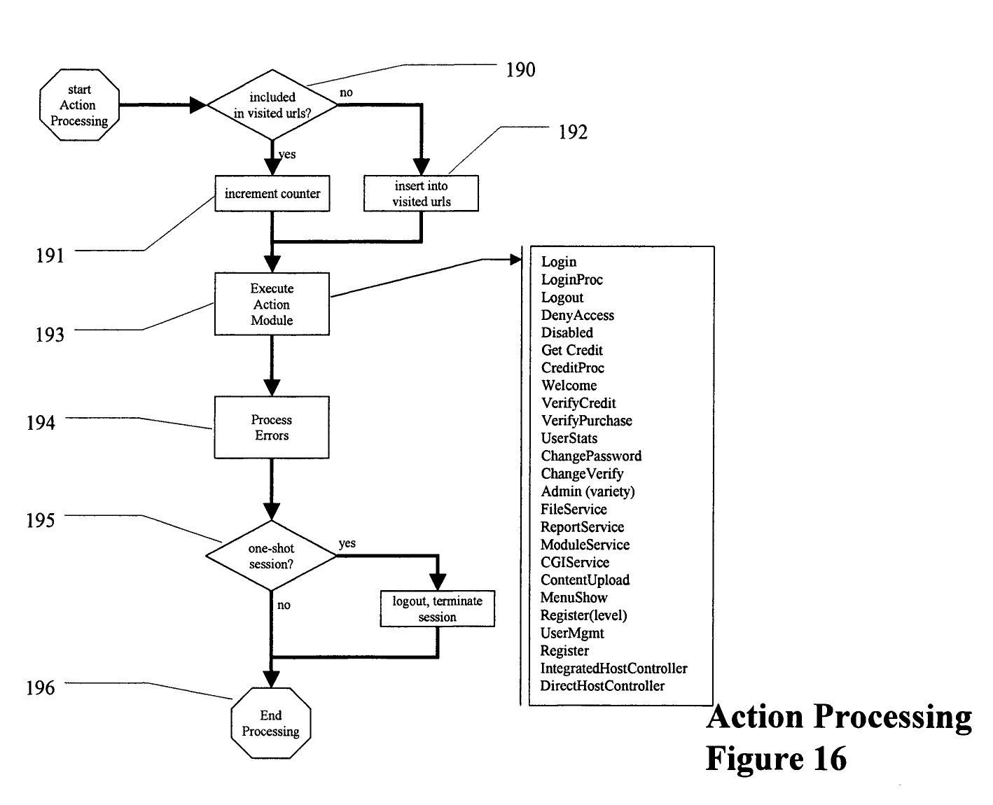

Then the system checks whether or not this request pertains to login or media resources, block 110. If so, the request is passed directly to Action Processing (see FIG. 16) without any further checks. This allows, for example, an HTML page to make repeated requests for images with minimum processing overhead.

At this point the system moves the URL stored as ‘current_url’ to the ‘previous_url’ location, and sets the current URL as ‘current_url’ as shown in block 111. This feature allows the system to keep track of the client's previous request, in the event that it needs to revert the client back to that request.

The next check determines if the request is a ‘one-shot’ request, block 112. This is a request that also contains authentication parameters and is intended to allow a request to be authenticated and serviced in a single processing action. Typically an automated client (which could be implemented by another installation using the same software) would use this kind of request as a reseller obtaining content from a wholesaler. If the request is of this type, a flag is set in the session that indicates the ‘one-shot’ type, the request URL is also saved in the session, and the request is redirected to the LoginProc module, whose operation is illustrated in a subsequent figure. What this does is basically to reformat the request and resubmit it—so it comes in to the start, block 108 and begins the process again—this time in the new format.

If the request is not ‘one-shot’, then the session is checked to determine if the session has been suspended, block 113. It does so by checking the value in the ‘expired’ property of the session object and determining if it is set to ‘true’. If so, the request URL is saved in the session, and the request replaced with a redirection to the Login module. This allows a user who has been inactive for a period to re-authenticate and then proceed with the original request in a smooth fashion.

If the session has not yet been suspended (that is, the ‘expired’ property is set to ‘false’), the system then checks to ensure that proper authentication has occurred, block 114. If not (as in the case where the request was the first one issued by a client), a check is made to determine if anonymous users are created by default as shown in block 115—this is a configurable option. If not, the URL is saved in the session object, and the request is resubmitted as a request for the Login module. If anonymous user default is supported, then the session is initialized with an anonymous user object, block 116.

Next, the system checks to determine if either the specific user, or the group to which that user belongs, has been disabled, block 120. If so, the request is ignored and a redirection to the Disabled module is issued.

If the user's access has not been disabled, the system checks to determine if this user is a master administrator as shown in block 121—this is the highest level of administrative rights that can be assigned to a user. If so, the request is processed directly without any further checking by Action Processing.

The next check is to determine if the user is requesting one of the system's ‘core’ modules (those that are needed for general operation). If so, it allows the request to be processed by Action Processing (described in FIG. 16) without further checking. If it is not a ‘core’ module, the next step is to check whether it is a module used by administrators to manage the system. If so, and if the requesting user is an administrator, control passes to Action Processing. Otherwise processing continues with Files/Reports Processing.

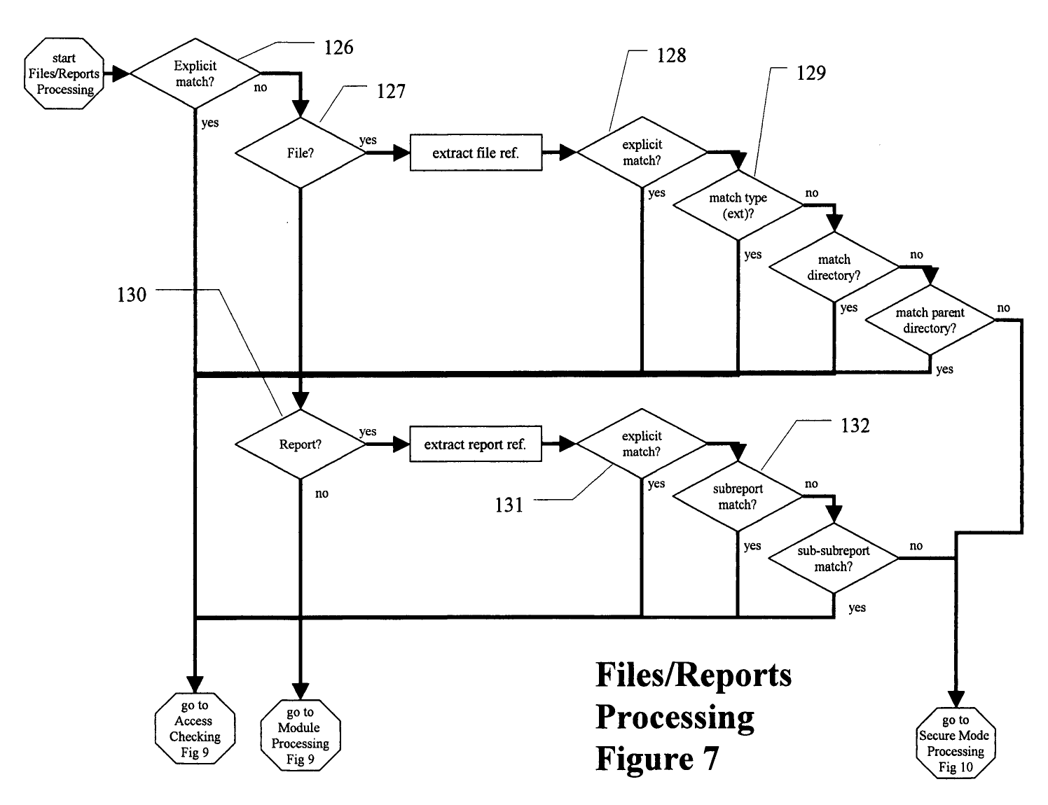

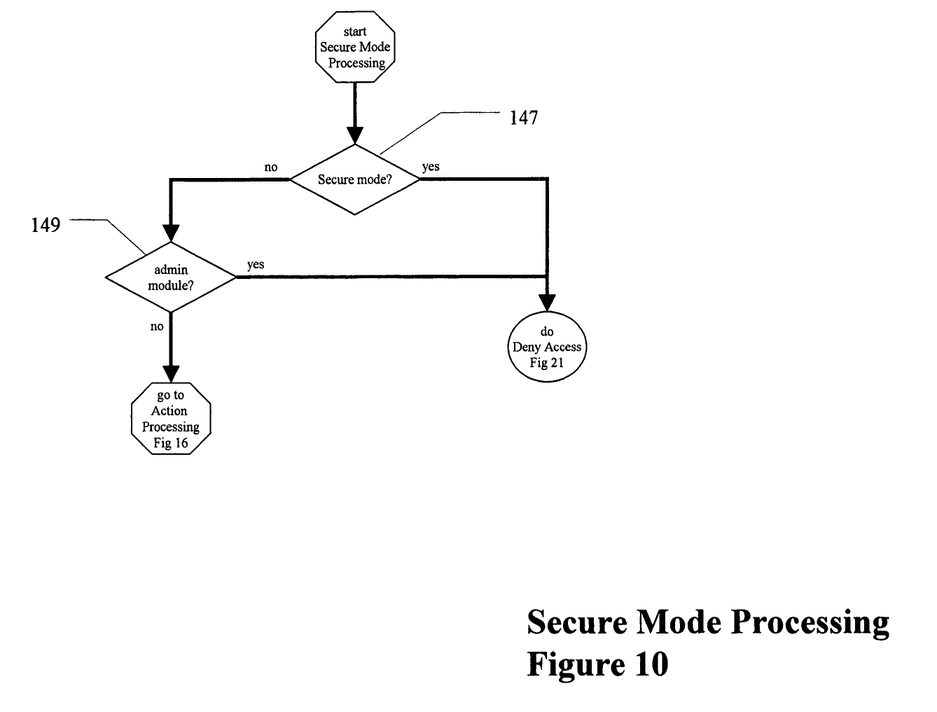

FIG. 7 describes the Files/Reports Processing logic used to match requests with defined resources. The system first, block 126, determines whether the request matches any resource defined by the administrator as a resource object, discussed earlier as in block 54 of FIG. 5a. It initially looks for a literal match to the request, block 126. If no such literal match exists, the system then determines if the request pertains to a file, block 127. If so, it then extracts the pertinent information from the request and converts it into the appropriate file format. Then it checks if that converted URL matches with a defined resource, as shown in block 129. If not, it then checks for a defined resource that has the same path and extension, but has a wildcard filename (in the form of—‘*.extension’). If not, it makes a check to see if a match can be found with a resource having the same pathname plus a wildcard. Finally, it checks to see if a match can be made with a resource having a parent directory with full coverage of subdirectories (in the form of two asterisks—‘**’). If this match fails, processing continues at block 147, FIG. 10.

This approach enormously simplifies the task of defining access conditions. For special cases, a file resource (which defines what can be accessed) may be defined literally and explicitly. But resources may also be defined as all files with the same ending, or all files in a directory (which corresponds to a category), or all files in a directory and all subdirectories. This means that a generic resource can be used to describe the general case of all files in a hierarchy, while specific exceptions can be defined by group (either by category or file extension) or can be defined specifically.

When extensive checking is done under high traffic conditions, performance may suffer. To handle this, the software allows configurable flags to be set that control the depth of directory checking that is done. For example, a system administrator may allow wild card matches only at the directory level (rather than at the subdirectory level), while another may require only literal matching. In other words, it is possible with a configuration parameter to disable checking at leach level of the wild-card-related file matching checks described above, as shown in block 129.

If the request is found not to pertain to a file, block 127, it is then checked to determine if it pertains to a report, block 130. If so, the request is converted to the appropriate report format and then checked to see if it matches a defined resource object, block 131. If not, a check is made to see if the request is a sub report to one that has been defined, block 132. If not, a check is made to see if the request matches to a lower level sub report that has been defined. If not, processing continues at Secure Mode Checking as illustrated in FIG. 10.

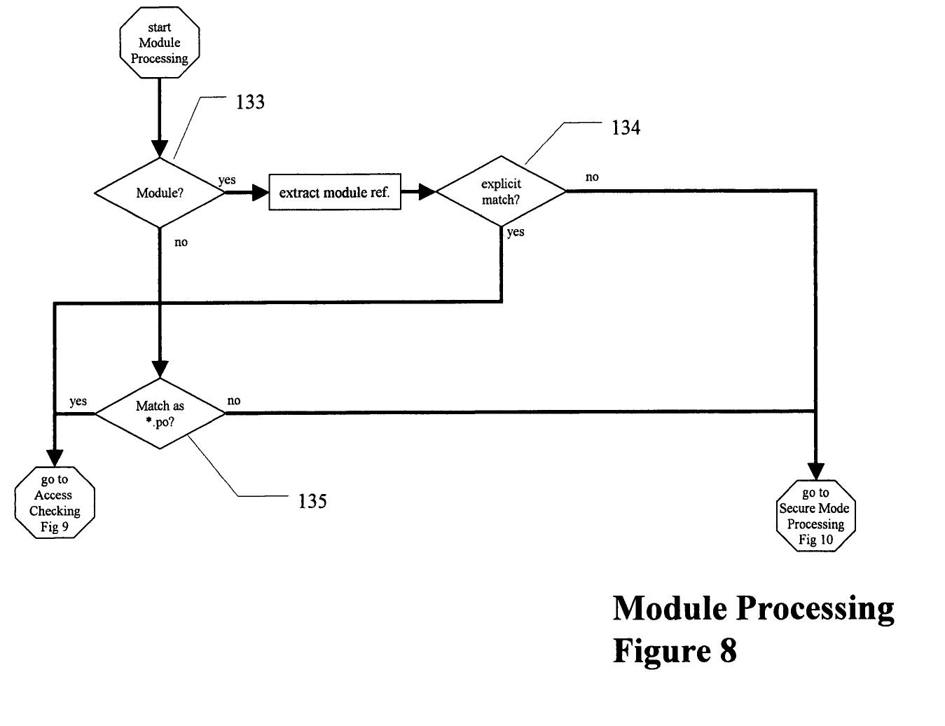

Referring back to FIG. 7, if the request is found not to pertain to a file 127 or a report 130, a final set of matching logic is employed, as illustrated in FIG. 8. The request is then checked to determine if it refers to a module, block 133. If so, the module reference is extracted and then checked to see if it matches a defined resource with that module, block 134. If not, control is passed to Secure Mode Checking, as described in FIG. 10.

If the request does not pertain to a module, block 133, the system makes a final categorical check to determine to see if it may pertain to a resource defined that matches all the intrinsic modules (*.po) as shown in block 135. If not, control is passed to Secure Mode Checking.

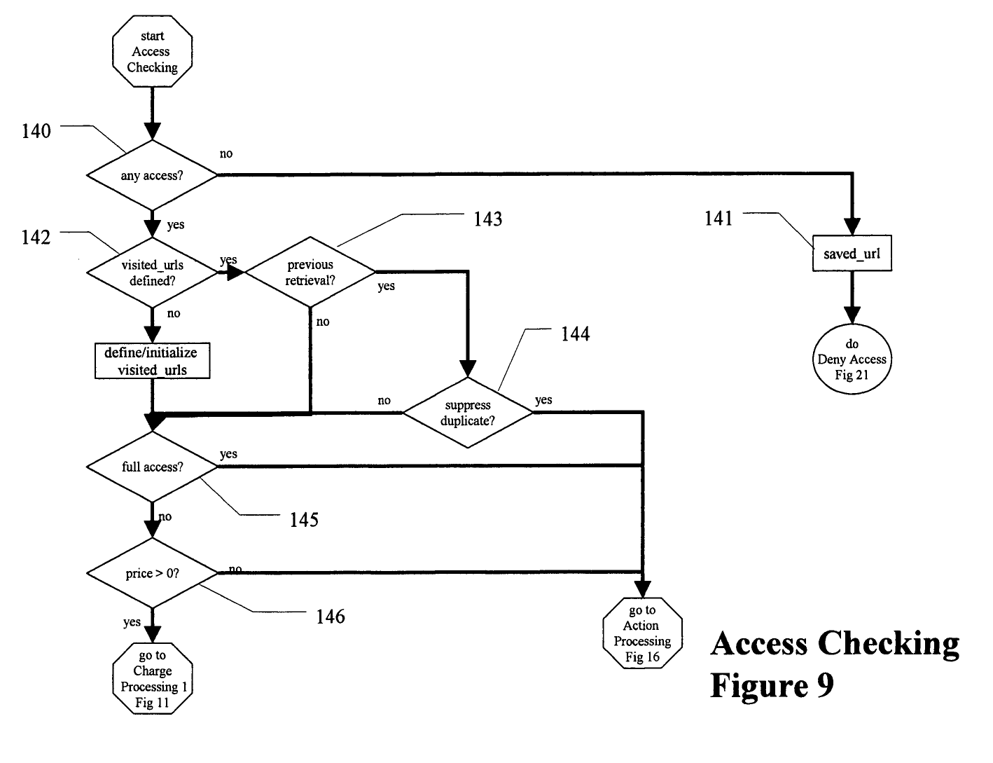

If any of the preceding checks in blocks 129 or 132 result in a match, the processing proceeds to Initial Access Processing, which is described in FIG. 9. Here the system checks to see if the current user has any access rights (that is, either full or conditional) to the resource being requested, block 140. If not, as shown in block 141, the request is saved in the ‘saved_url’ property of the session object, previously referenced in FIG. 5c, and resubmitted as a Deny Access request.

Next, the system checks to see if the ‘visited_urls’ property has been defined, block 142. This is a property of the session object. If this property has not been defined, it is created and initialized with the current request URL. Processing then continues at block 145, as described below.

If the ‘visited_urls’ property does exist, block 142, its contents are checked, as shown in block 143, to see if the currently requested resource has previously been requested during the current session. If so, the system checks how the resource object, previously references in FIG. 5a, has set the property flag ‘suppress duplicates’, block 144. If this property is set to true, it means that the user should not be charged again for accessing this resource during the current session. The request is thus routed to Action Processing (see FIG. 16) to continue processing.

If the ‘suppress duplicates’ flag is set to ‘false’, or if the request is unique 142, the system checks, as shown in block 145, to see if the user has been granted full, unconditional access rights. If so, the request is thus routed to Action Processing (see FIG. 16) to continue processing.

If the system was unable to find a defined resource object matching the requested resource (in either blocks 129 or 132 of FIG. 7), processing is continued in Secure Mode Checking as illustrated in FIG. 10. As shown in block 147 the system checks the setting of the ‘secure_mode’ property of the associated subscription plan object. This allows the system to operate simultaneously in two modes, depending on the subscription plan to which the user is assigned. When the ‘secure_mode’ property is set to ‘true’, access by a user assigned to that subscription plan will be denied for any request that fails to match a defined resource. If the ‘secure_mode’ property is set to ‘false’, then after a final check to ensure that the user is not requesting an administrative module (see block 32, FIG. 4b), access will be granted to any request when a matching resource is not defined. At this point, the request is processed without any further checks or charge calculations. Should the request be for an administrative module, access will be denied.

If in block 145, FIG. 9, it is determined that the user has conditional but not full access rights, the next step is to determine if the price associated with the resource is greater than zero, and if so, to compute the incremental charges that may apply Charge Processing 1 as described in FIG. 11.

As shown in block 150, this computation starts with the list price, (a property of the resource object, which is then multiplied by any discount, found as properties of the plan object referenced previously in FIG. 5c. These discounts may be defined by the plan as fixed percentages and/or they may be dynamic, based on the users' purchase volume.

A group may have an account balance and may also have a credit balance. The credit balance also has a limit associated with it to specify what is the maximum credit that will be granted to this group (and all of it's member/users). Both the account balance and the credit balance may have an associated factor that is designed to limit how much of each balance may be allocated to any individual user. This is to ensure that any individual user doesn't ‘hog’ all the balances. This means that the system must not only check each balance at the group level, but also ensure that the charges don't exceed the user's portion of that group's balance.

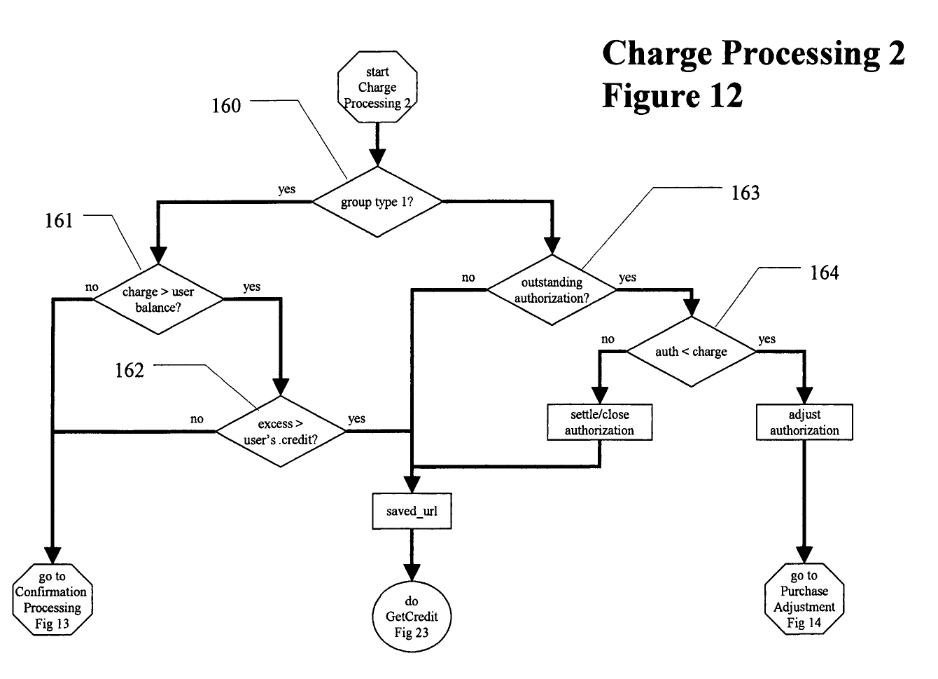

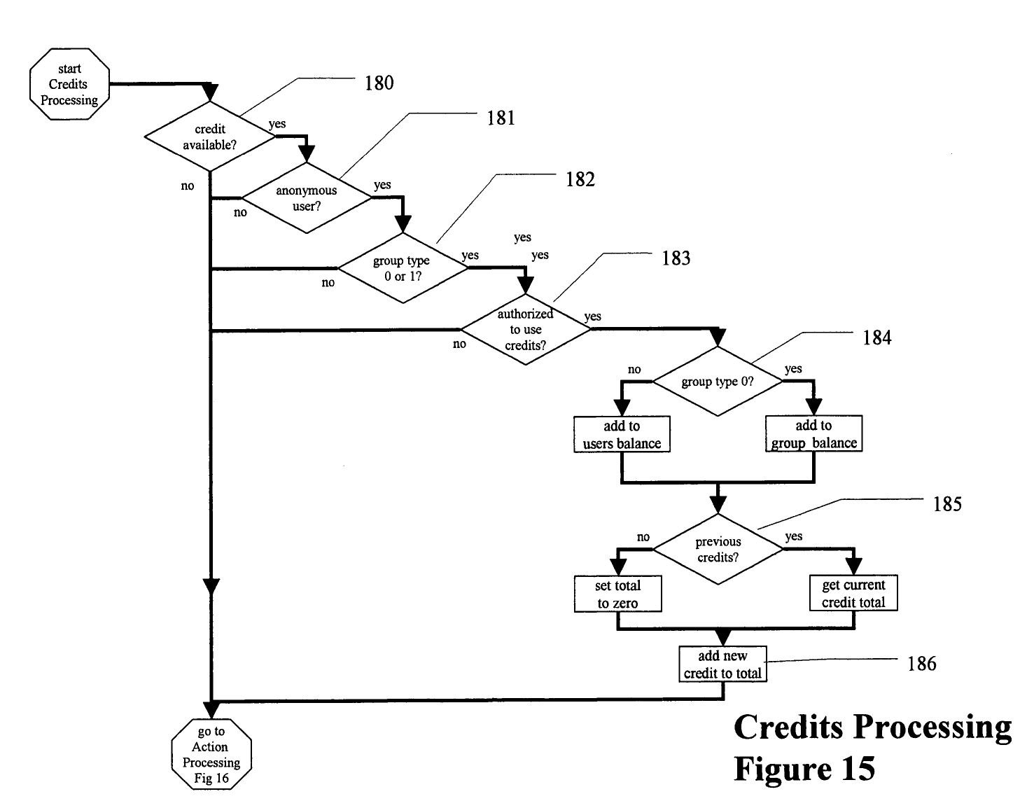

Once the charge is computed, the system checks to determine if it is greater than zero. If not, the processing proceeds to Credits Processing, as illustrated in FIG. 15. If the charge is non-zero, the system then checks if the user's group is a shared one, which is designated as a group with a type equal to ‘0’ as shown in block 152 of FIG. 11. If that is not the case, processing continues with Charge Processing 2, shown in FIG. 12. If the group is type ‘0’ and if the charge exceeds the group balance, block 153 of FIG. 11. If not, then it must also check if it exceeds the user's portion of this balance, block 155. If the amount does not exceed the group balance but does exceed the portion that is assigned to the then-active user, the request is saved, block 157 and the user is redirected to a GetCredit request.

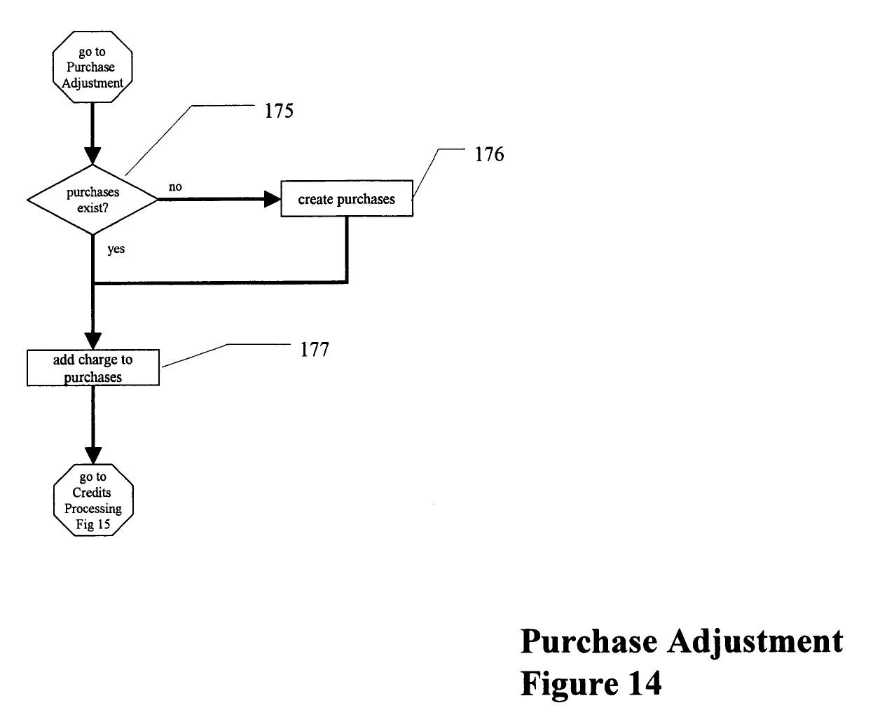

If the check against the group balance, block 153 results in a determination that the group's overall balance is not sufficient to cover the charge, the system will check if the group's credit limit will cover it, block 154. If not, the request is resubmitted as a GetCredit request, as described above. If so, the system checks if the user's allowable portion of this group credit is sufficient to cover the charge, block 156. If the needed amount exceeds the proportion of the group credit allowable to the user, the request is saved, as shown in block 157, and the user is redirected to GetCredit, as described above. Otherwise processing continues in Purchase Adjustments, as illustrated in FIG. 14. If the system determines, block 155 that the charge was within the limits of the user's allocation, it then passes control to Charge Confirmation.

As shown in block 152, if the user's group is not of type ‘0’, processing continues as described in Charge Processing 2, shown in FIG. 12. First, the system checks if the user belongs to a type ‘1’ or ‘2’ group, block 160. If it is a type ‘1’ group, the system checks if charge amount can be covered by the user's individual account balance, block 161. If not, it then determines if the user has a credit balance available, and if so, whether the combination of the account balance and available credit are sufficient to cover the charge, block 162. If not, the request is saved and control is passed to the GetCredit module.

As shown in block 160, if it is determined that the user's group is type ‘2’, the next check is whether or not there is an outstanding authorization, block 163. If not, the user's request is saved and processing is redirected to the GetCredit module. If an outstanding authorization exists, then it is checked to determine if it is sufficient to cover the charge, block 164. If not, the authorization is settled with the payment processing system, the request is saved, and the user is redirected to the GetCredit module. If the level of the outstanding authorization is sufficient to cover the charge, that charge is deducted from the available authorized amount, and processing proceeds to Purchase Adjustment, described in FIG. 14.

If the user balances are sufficient to cover the charge (as determined from block 155 or 156 of FIG. 11, or blocks 160 or 161 of FIG. 12, the then system performs user confirmation as described in FIG. 13. The system first checks if the confirm flag is set, block 168. The user may elect to confirm each purchase before it is committed. If that option is selected, the confirm flag is set to true, and the system then checks if the current URL is the same one that was set to be confirmed by the previous request by this user, block 169. If it is not (as would be the case when the original request was first processed), the request URL is saved in the ‘confirmed_purchase’ property of the session object, as shown in block 170.

In addition to setting the flag that activates the confirmation process, the user may also fine-tune the confirmation process. The user may set a charge amount such that, charges below that amount are processed without explicit confirmation. The user may also select a further condition, based on several possible factors, such as the cumulative charges incurred in the current session or the cumulative charge obligation. If these are set, then charges below the user-defined threshold are not explicitly confirmed unless the cumulative amount has been met. In this way, the user may adjust the process to provide the best balance between close monitoring of charges with smooth operation.

If system determined 169 that the current URL matched that in the ‘confirmed_Purchase’property, the ‘confirmed_purchase’ property is cleared, block 171, and the charge is deducted from both the group's and the user's accounts, block 172. If the confirm flag was found to be set to ‘false’, block 168, the charge is also deducted from both the group's and the user's accounts, block 172. At this point processing continues with Purchase Adjustments, described in FIG. 14.

At this point processing continues with Purchase Adjustments, where, as shown in block 175, the system checks to see if the ‘purchases’ property of the session object has been created. If not, it creates it, as shown in block 176. Then the newly charged amount is added to the ‘purchases property’, block 177, and processing continues to Credits Processing, as illustrated in FIG. 15.

At this point, the user has been properly charged, and the system now checks to see if user credits are available, block 180. Each resource object has a ‘credits’ property. If plan object associated with the user has its ‘use_credits’ flag set to ‘true’, then any credits defined in the resource object are applied to that individual user's and/or user's group account balance.

In the process of making this decision, the system determines if the user is ‘anonymous’, block 181, in which case, in the preferred embodiment, credits are excluded. If the user is not anonymous, as shown in block 182, the system then checks whether the user's group is either type 0 or 1 and, if so, whether the user is authorized to have credits granted, block 183, by checking the ‘use_credits’ property of the user's plan, as described above. If the user is not authorized, credits are not applied. However, if credits may be granted either the user's balance or the user's group balance is adjusted for them, block 184. Then the system checks, as shown in block 185, if the ‘credits’ property of the user's session object has been created. If not, it creates it and sets the total to zero. If previous credits have been collected during the session, the system obtains this total from the ‘credits’ property. Then the total previous credits are added to the current credits and the ‘credits’ property reset to that total, block 186.

When the credit checking and processing has been completed, processing continues with FIG. 16, which illustrates the Action Processing operation. As shown in block 190, the system checks to see if the requested URL is included in the ‘visited_urls’ property. If not, the requested URL is added to the ‘visited_urls’ property, block 191. If the requested URL is already included, the counter associated with it (part of the ‘visited_urls’ property) is incremented, block 192.

At this point the system, as illustrated at block 193, executes the action module referred to by the request. All of the processing up to this point has been focused on whether to execute the request (for the user making the request), and if so, whether the appropriate financial conditions have been met. Now the actual execution occurs.

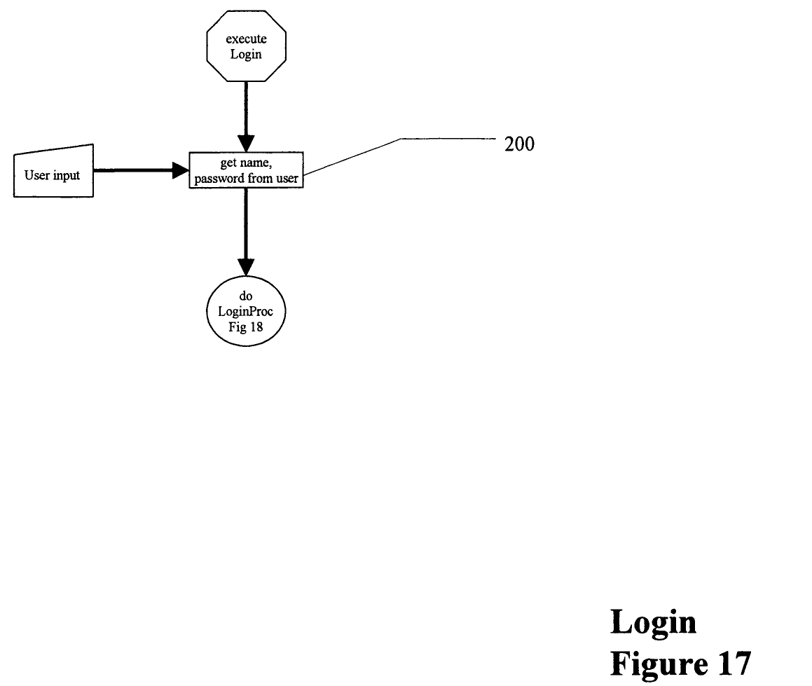

As shown previously in FIG. 4b, block 32, some of the action modules that are executed are part of the core of the software system, such as the Login module and it's associated LoginProc and LoginMessage modules. The functions of these modules are explained in FIGS. 17, 18 and 19 respectively. From the point where the execution is initiated 193, processing occurs as defined by the particular module being executed.

An action module may be implemented in many different ways. But any such module will usually consist of a portion that handles the module-specific processing, and a portion that handles the module-specific generation of output (as HTML, XML, etc.). Each module has access to the then-active user's session information as well as, to the degree appropriate, other internal system data. Also, one action module may cause the user to be redirected to another action module, when a series of processing actions is required.

At this point the system checks for any errors, block 194. The precise logic for dealing with errors is a function of the module that was executed (or attempted to be executed, as the case may be). In general, the error processing procedures are primarily designed to ensure that users are not charged for resources they didn't actually get (because of some error). In some cases, it may be desirable for the action module to detect the error itself and take appropriate action (including, as mentioned above, possibly causing a different action module to be invoked).

Once the error processing has been completed, the system will check to determine if the request was in the form of a ‘one-shot’ request or not, block 195. A ‘one-shot’ request is one in which the request is accompanied by authentication credentials; it is normally issued by a program (rather than a human user). If the request is of a ‘one-shot’ nature, the system will then check the associated mode. If it is set to indicate an immediate session, the system will then delete the associated session object.

At this point, as shown at block 196, processing of the request is complete, and the system execution thread created to handle this request is terminated. Most, but not all, modules provide information back to the user—but user feedback is a function of the modules, not the core system.

Now the portion of the processing handled by each of the core modules (occurring within block 193 of FIG. 16) will be described.

The purpose of the Login module, whose functions are illustrated in FIG. 17, is to request a name and password from the user. It does so by publishing a form on the user's client software (usually a web browser) with data entry items for the name and password. Once the user fills in the form, and hits the ‘submit’ button, block 200, the name and password (in the preferred embodiment, in an encrypted form, provided either directly or indirectly, though a form of link encryption, such as Secure Sockets Layer, or SSL) are sent back to the server (and the software behind it) in the form of a request for the LoginProc module.

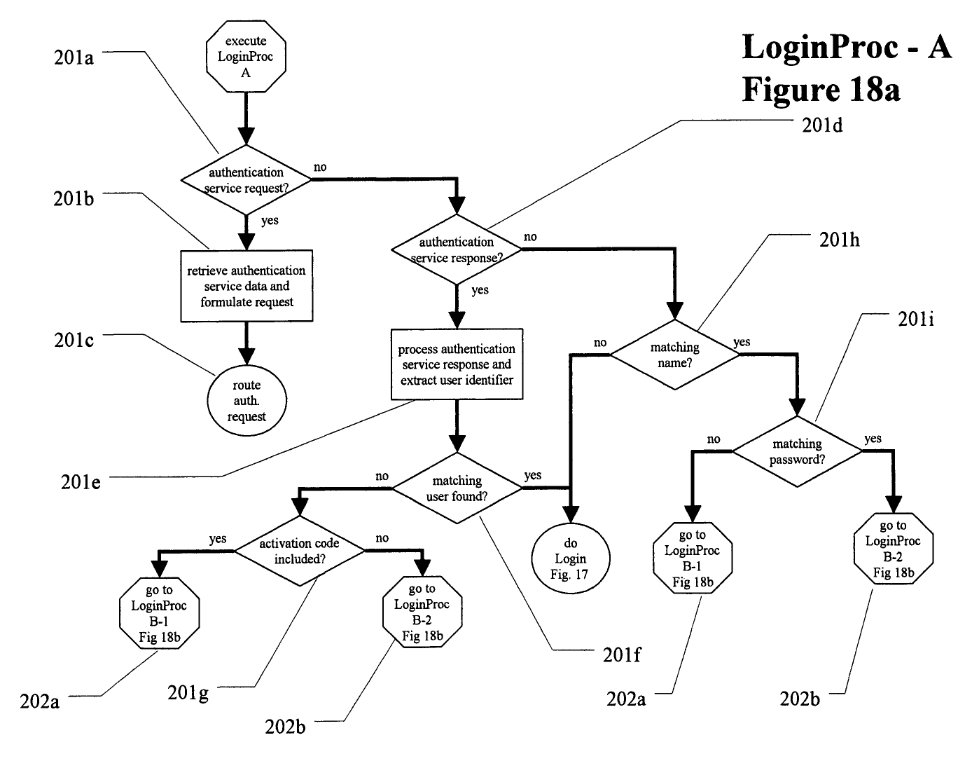

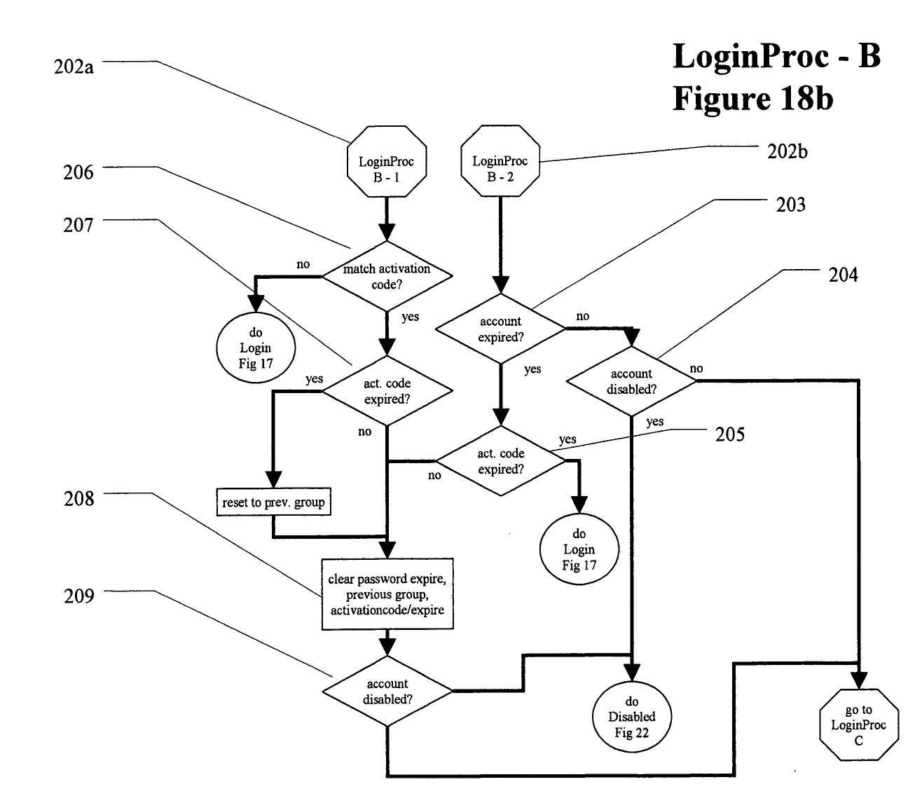

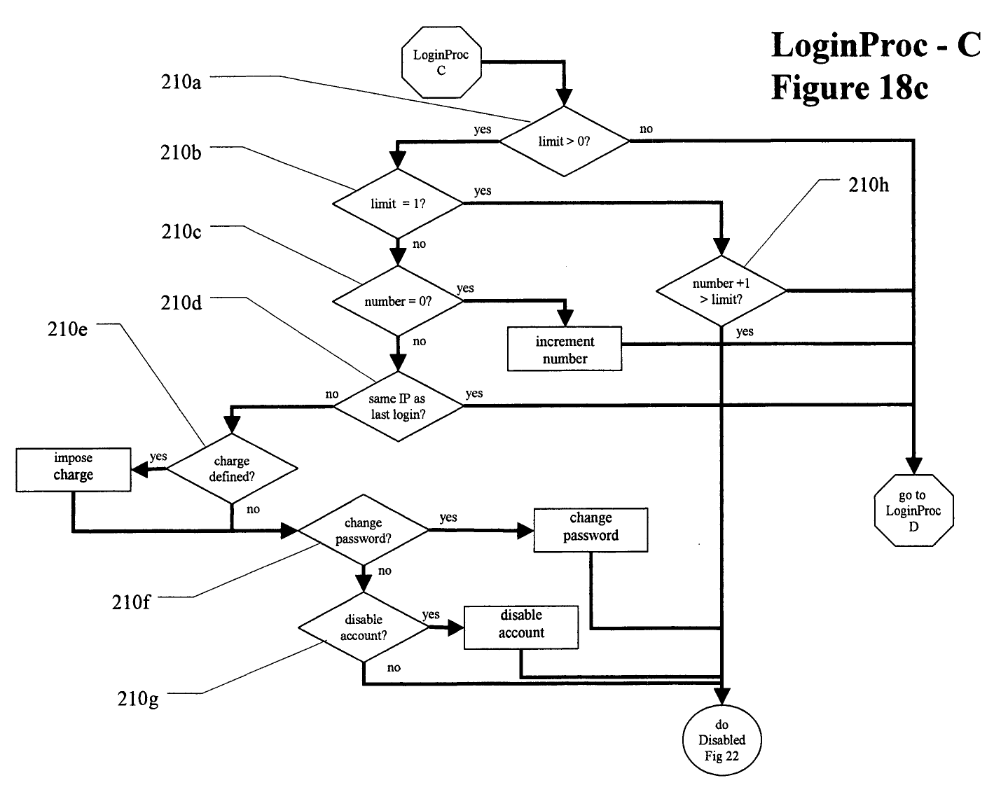

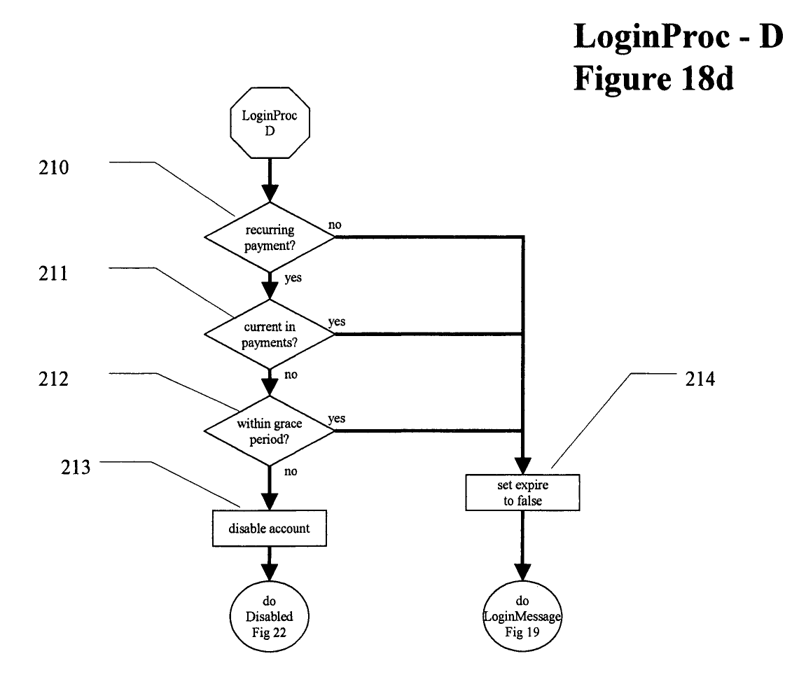

The process of logging-in users is illustrated in FIGS. 18a, 18b, 18c and 18d. Starting with FIG. 18a, LoginProc first checks if the request is an initial selection of an authentication service, as shown at block 201a. If so, it extracts any information needed by the selected authentication service, block 201b, and then routes the properly formatted request to the appropriate authentication server, block 201c. In the preferred implementation, the routing of the formatted request to the authentication server is accomplished through a client-side redirection message, but it is understood that this routing might be accomplished in a variety of other ways, including a request being made directly by Web-Exec to the authentication server. The logic described herein is illustrative of that required to integrate an specific authentication service, but it is understood that the precise logic will vary, depending on each service provider's offering.

For requests not involving initial authentication service processing, as shown at block 201d, the system then checks if the request contains a response from an authentication server. If so, as shown at block 201e, it then determines what authentication processing module to use and uses that module to determine if the user's identity has been successfully verified by the authentication service. If, as shown at block 201f, the processing determines that the authentication is successful, it will extract the authenticated user's identifier, and check for an activation code, block 201g. If authentication failed, block 201f in FIG. 18a, the user is redirected to Login, described in FIG. 17. As shown in block 201g, if authentication succeeded the system then determines if the request includes an activation code. If so, processing continues at block 202a; otherwise it continues at block 202b.

For requests not pertaining to use of an authentication service, as shown at block 201h of FIG. 18a, the system assumes that local authentication is being used and checks whether a user object is found with a name matching that supplied with the request. If not, or if a name is not included in the request, the request is redirected to the Login module described in FIG. 17. If a match is found, the system then checks, block 201i, if the supplied password matches that of the selected user object (matched by the name). If the password matches, processing continues at block 202b; otherwise, processing continues at block 202a. While the in the preferred embodiment credentials used for local authentication take the form of a name and password, it is recognized that credentials may take many other forms, including but not limited to client address and digital certificates

If the request represents an authentication service response with an included activation code, block 201g, or if it represents a local authentication request in which the password match failed, processing continues at block 202a in FIG. 18b. The system then checks, block 206, to see if the activation code supplied with the request matches that associated with the user object. If not, the request is redirected to the Login module. If the supplied activation code matches that of the user object, block 207, the system then determines if the user object's activation code has expired. If so, the user group associated with the user is reset to that which existed prior to the assignment of the activation code (which is the group to which the user belonged prior to self-registering for another group). Then the properties associated with the activation code are all cleared, as shown in block 208.

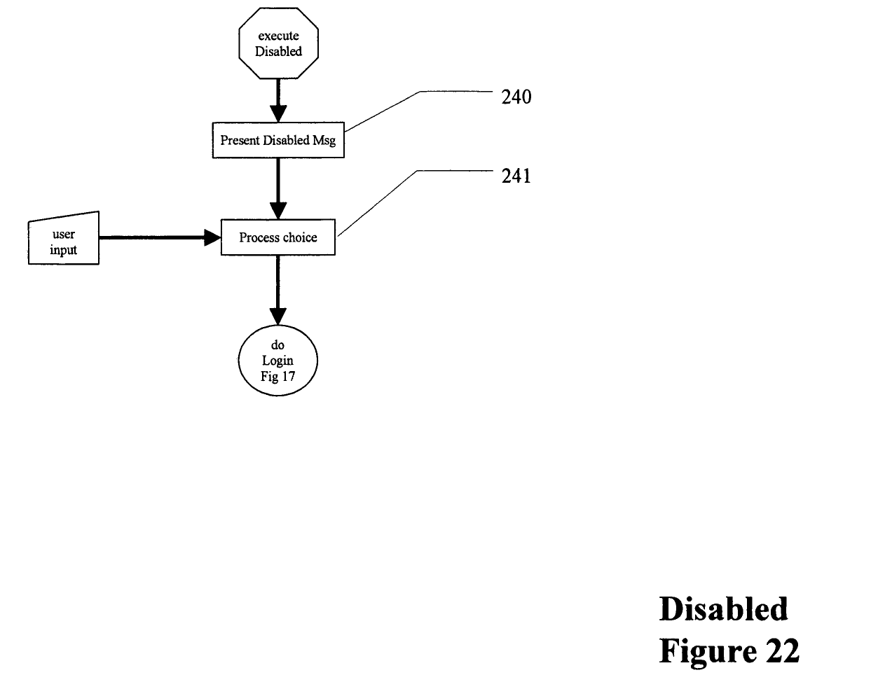

If the request represents an authentication response with no included activation code, or a successful local authentication request, processing continues at block 202b in FIG. 18b. Here the system checks to determine if the account is expired, block 203. If so, it then determines if there is an activation code that has expired, block 205. If so, the request is redirected to the Login module. Otherwise processing continues at block 208, as discussed above, where the system next checks to determine if the account has been disabled, as shown at block 209. If the account has been disabled, the request is redirected to the Disabled module described in FIG. 22.

Login processing continues as shown in FIG. 18c, which illustrates the detailed process used by the system to enforce any specified concurrent user limits. In general, if concurrency limits have been exceeded, the user is denied access and routed to the Disabled module described in FIG. 22. Otherwise, the processing continues as described in FIG. 18d.

The specific steps begin with the system checking if the user has a concurrent limit, as shown in block 210a, FIG. 18c. If not, processing continues with FIG. 18d. If the normal concurrent limit of 1 exists, which is checked at block 210b of FIG. 18c, and there are no other clients authenticated under this user, as shown in 210c, FIG. 18c, the system increments the value of the concurrent_number (showing number of active clients authenticated under this user), and processing continues as shown in FIG. 18d.

If the system detects that another client has already authenticated with this user object, but has the same IP address as the other authenticated user, block 210d, FIG. 18c, processing continues as shown in FIG. 18d. If the IP address is different, the system determines that the client attempting to authenticate should be denied; if a charge has been specified, block 210e, FIG. 18c, the system imposes it. If the change password action has been specified, block 210f, the system generates a new password, changes the user's password to the new one, and informs the user of the change. If the disable action has been specified, block 210g, the system disables the user object account and notifies the user of this action. If, at block 210b, the system determines that the user object permits concurrent use by multiple clients (that is, the limit is greater than 1), it then checks whether the addition of the requesting user will exceed the limit, block 210h. If so, access is denied and processing is continued by the Disabled module described in FIG. 22. If not, processing continues as shown in FIG. 18d.

FIG. 18d shows the last part of login processing. After the checks for concurrent users (just described in FIG. 18c) are made, the system checks if the user is responsible for paying a recurring charge, as illustrated in block 210 of FIG. 18d, and if so, whether the payments are up to date, block 211, or if not, if they are within the grace period, block 212. If not, the account is disabled, block 213, and the request is resubmitted as a Disabled request, including an explanatory message.

If the user does not have a recurring payment obligation, block 210, or has one and is current in his/her payments 211, or is delinquent but within the grace period, block 212, the system proceeds to set the ‘expire’ property of the session object to ‘false’, as shown in block 214. (This resets the timer for the 1^{st} of the 2-phase inactivity expiration process.) Then the user is redirected to the LoginMessage module.

FIG. 18c illustrates the detailed process used by the system to enforce any specified concurrent user limits. In general, if concurrency limits have been exceeded, the user is denied access and routed to the Disabled module (FIG. 22). Otherwise, the processing continues with block 210 in FIG. 18d.

Specifically, the system first determines if the user has a concurrent limit, as shown in block 210a, FIG. 18c. If not, processing continues, reverting back to block 210, FIG. 18d. If the normal concurrent limit of 1 exists, which is checked at block 210b of FIG. 18c, and there are no other clients authenticated under this user, as shown in 210c, FIG. 18c, the system increments the value of the concurrent_number (showing number of active clients authenticated under this user), and processing continues at block 210, FIG. 18d.

If the system detects that another client has already authenticated with this user object, but has the same IP address as the other authenticated user, block 210d, FIG. 18c, processing continues at block 210, FIG. 18d. If the IP address is different, the system determines that the client attempting to authenticate should be denied; if a charge has been specified, block 210e, FIG. 18c, the system imposes it. If the change password action has been specified, block 210f, the system generates a new password, changes the user's password to the new one, and informs the user of the change. If the disable action has been specified, block 210g, the system disables the user object account and notifies the user of this action. If, at block 210b, the system determines that the user object permits concurrent use by multiple clients (that is, the limit is greater than 1), it then checks whether the addition of the requesting user will exceed the limit, block 210h. If so, access is denied. If not, processing continues at block 210, FIG. 18d.

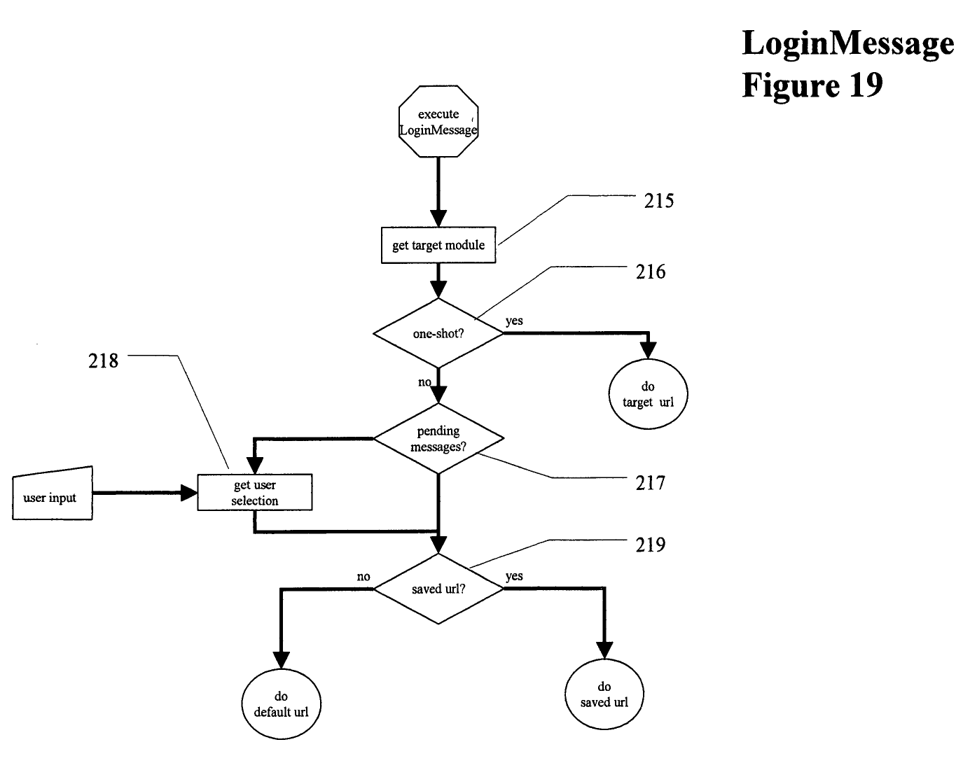

FIG. 19 illustrates the processing handled by the LoginMessage module. It begins by extracting the target module, block 215, and saving it for later processing. Next, it determines if the request is of the ‘one-shot’ type, block 216, in which case the user is immediately redirected to the associated target url.

Otherwise, the system checks for any pending messages addressed to the user, as shown at block 217. If so, the user is informed of these and offered an opportunity to view them, block 218. Then processing in this module concludes by routing the user to the target module, block 219.

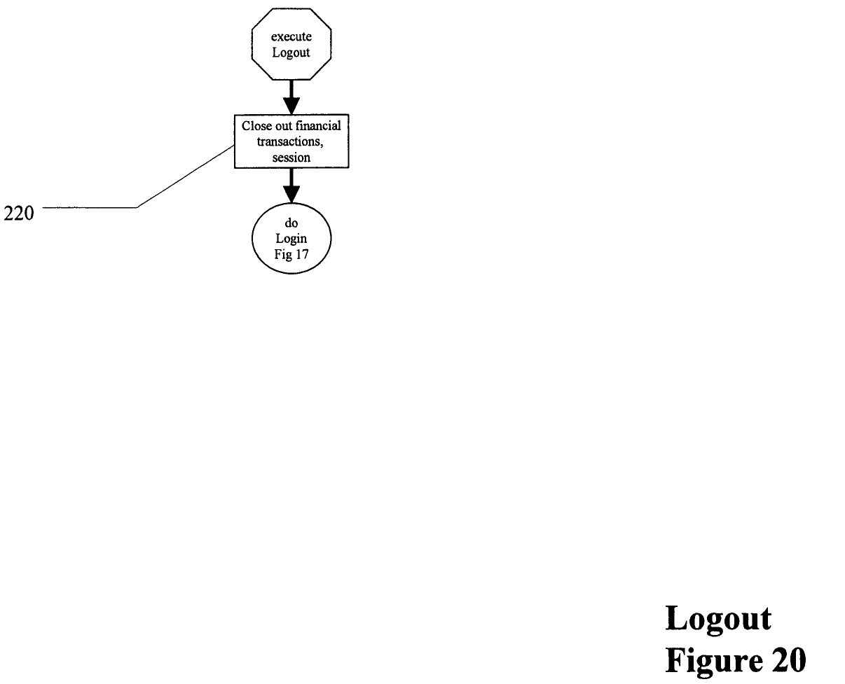

FIG. 20 illustrates the operation of the Logout module. This is designed to be invoked by an action of the user to either suspend or terminate that user's session. If called with the ‘suspend’ parameter, the system merely puts the user's session into the ‘suspend’ state. Otherwise, the system closes out the session, completing any pending financial/credit transaction, and making appropriate entries in the log, block 220. The system then decrements the concurrent_number property of the user object, shown in FIG. 5c, providing that the value of this property not be set lower than zero. Then the system resubmits the request to the Login module.

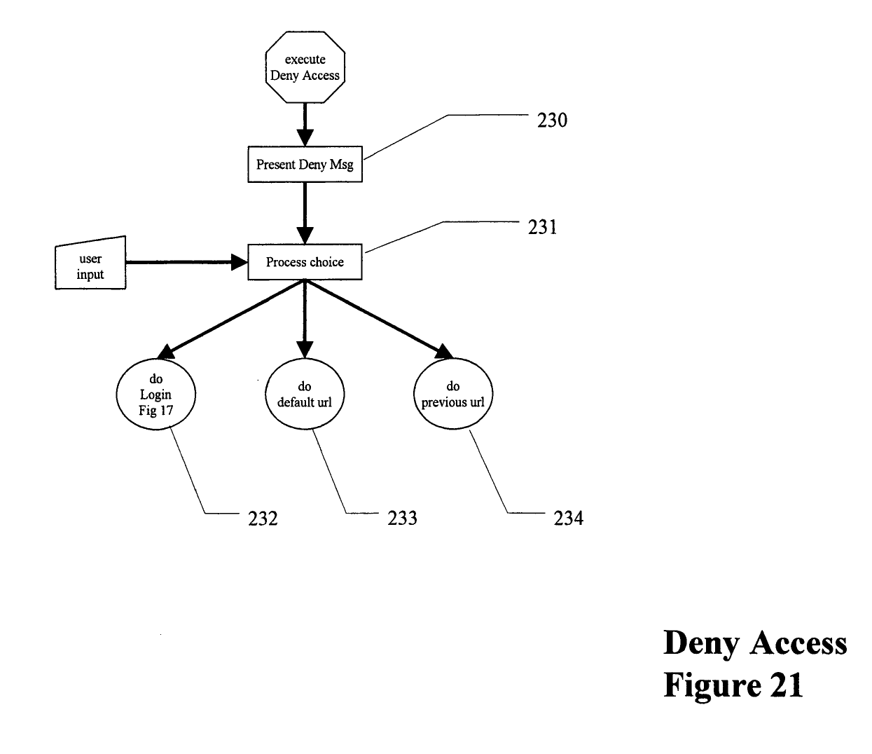

FIG. 21 shows the operation of the DenyAccess module. Here the user is informed in the event that he/she does not have sufficient rights to retrieve the specified resource or service, block 230. It then presents the user with several options for the user's selection, block 231. In the preferred embodiment there are three choices provided. The first is to redirect the user to the Login module, block 232, which the user would select if they had knowledge of another set of credentials that would allow the access. When the software redirected the original request to this module (as, for example, FIG. 9 block 143) the original request was saved in the user's session's ‘saved_url’ property before being redirected to DenyAccess. Thus it is available should the user choose to be redirected to the Login module.

The second option in the preferred embodiment is to be redirected to the default opening page, as shown at block 233. The third option in the preferred embodiment is to be redirected to the previous page, block 234. In such a case, the system extracts the contents of the ‘previous_url’ property of the session object and uses this as the new target module.

The operation of the Disabled module is illustrated in FIG. 22. This module is invoked by the system when a user attempts to login when that user's account has been disabled (as in FIG. 6b, block 120). In such a case, the system presents the user with a message informing him of the disabled nature of his account, block 240, which could have been set at either the group level or the individual user level. The user is then presented with the option to login as a different user (whose account presumably isn't disabled). When the user selects this option, as show at block 241, the system redirects the user back to the Login module.

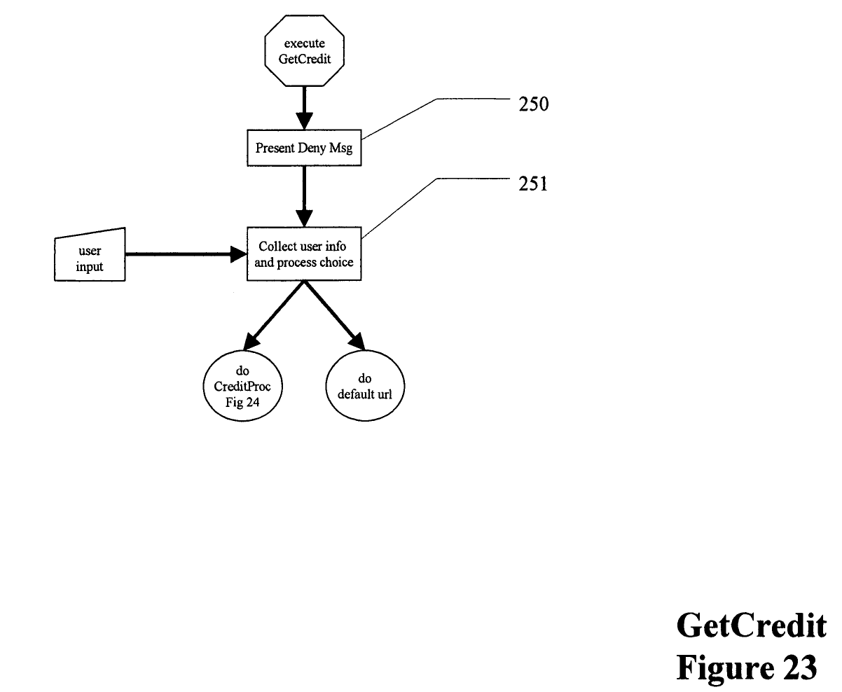

FIG. 23 shows the operation of the GetCredit module. This module is invoked when the system determines that insufficient credit is available (when added to the user's account balance) to cover a charge for a requested resource (as in FIG. 11, block 154). In such an event the system presents the user with a message indicating the amount of credit required and requesting credit information from him/her, block 250. The user is also informed that it would be advisable to authorize more than simply that needed to cover this immediate charge. That way the user will be able to make subsequent purchases without being interrupted to obtain more credit.

If the user is anonymous (or a member of a type ‘2’ group) the amount of credit authorized may—at the user's option—be greater than that required to cover the pending charge. Any excess will be saved for the duration of the user's current session, potentially available for other purchases. Then, when that user logs out (either explicitly or through a timeout), the credit transaction will be settled (a process in which any excess funds authorized will be returned to the user's account). For all other users, any excess amounts obtained will be stored, either in the user's, or the user's group, account as appropriate, available for subsequent purchases during this and subsequent sessions. Once the user has provided the desired information and made the desired selection, the system then collects the information and processes the user's choice of action, block 251. In the preferred embodiment there are two choices: first, proceed to the CreditProc module, or alternatively, proceed to the default url (implemented as the Welcome module, in the preferred embodiment).

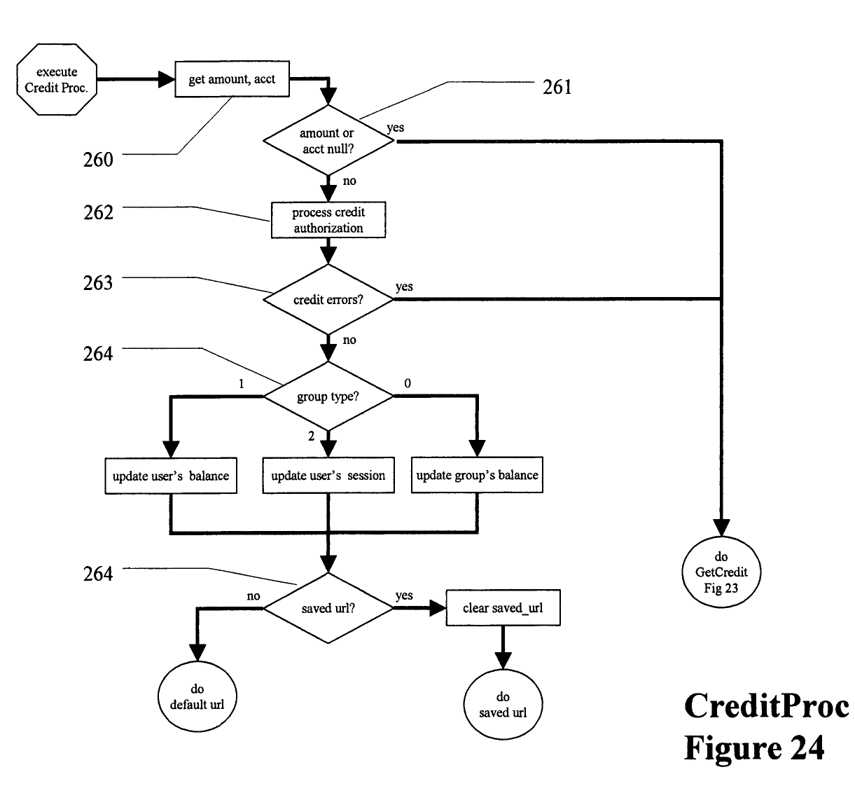

FIG. 24 illustrates the operation of the CreditProc module, which is invoked by the system from the GetCredit module, previously references in FIG. 23. In this case the system attempts to extract the key information that should have been provided on it's invocation, block 260. If any information is missing, the request is resubmitted as a request back to the GetCredit module, block 261.

Otherwise, the system then processes the request for additional credit funds, block 262. Though this process may involve debit accounts and other forms of financial assets, in the preferred embodiment this involves collecting a credit card account number and expiration date from the user, computing all relevant additional charges and taxes, and submitting this to an appropriate payment authorization service. If the service involves credit cards, it will attempt to set aside (‘authorize’) the stated amount for later settlement (except in the case where the charge and requested credit are equal, in which case the authorization and settlement occur in the same credit transaction.) Otherwise, the requested amount, if available, will be transferred to the requesting user's local individual or group, as appropriate, account balance.

As shown at block 263, if there is a failure in the process to gain additional credit, the system resubmits the request to GetCredit to try again. Otherwise it proceeds, by updating, as appropriate based on the user's group type, either the user's individual or group account, or the user's session-based account, block 264. After this the system checks for the presence of a request in the ‘saved_url’ property of the session object, block 265. Normally a request will be found there, in which case the request is resubmitted to that URL. Otherwise, it is resubmitted to the default module.

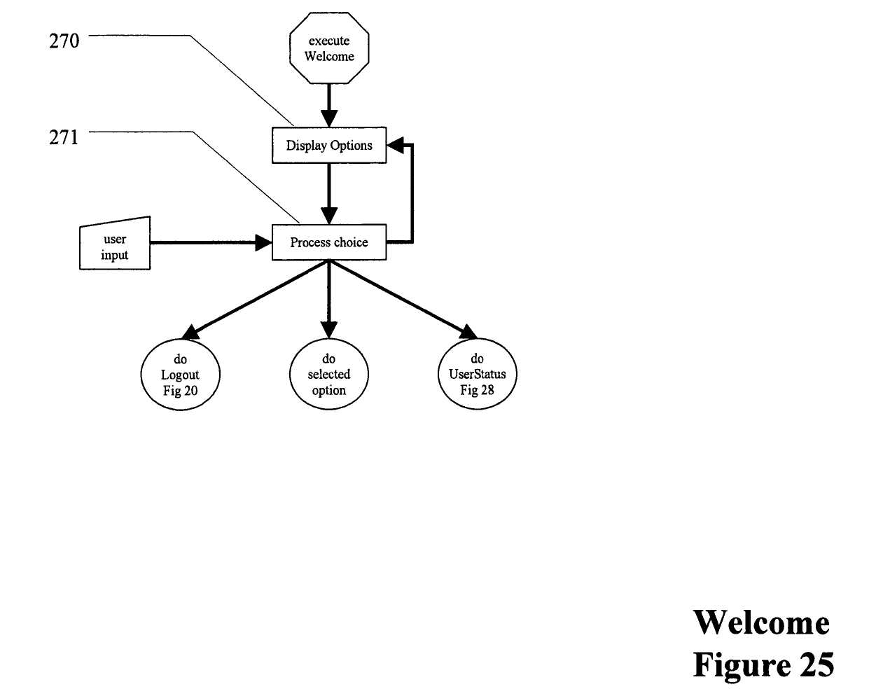

The operation of the Welcome module is shown in FIG. 25. This module is invoked by the default url (initial page) in the preferred embodiment. Its purpose is to display an appropriate set of options to the user, block 270, which may include multiple pages with appropriate controls for navigating among the pages and to process the user's choice, block 271. The contents of these options are extracted from files created by the administrative tools that handle the maintenance of the subscription plan and resource objects. In the preferred embodiment these options always include a redirection to the Logout module and a redirection to the UserStatus module.

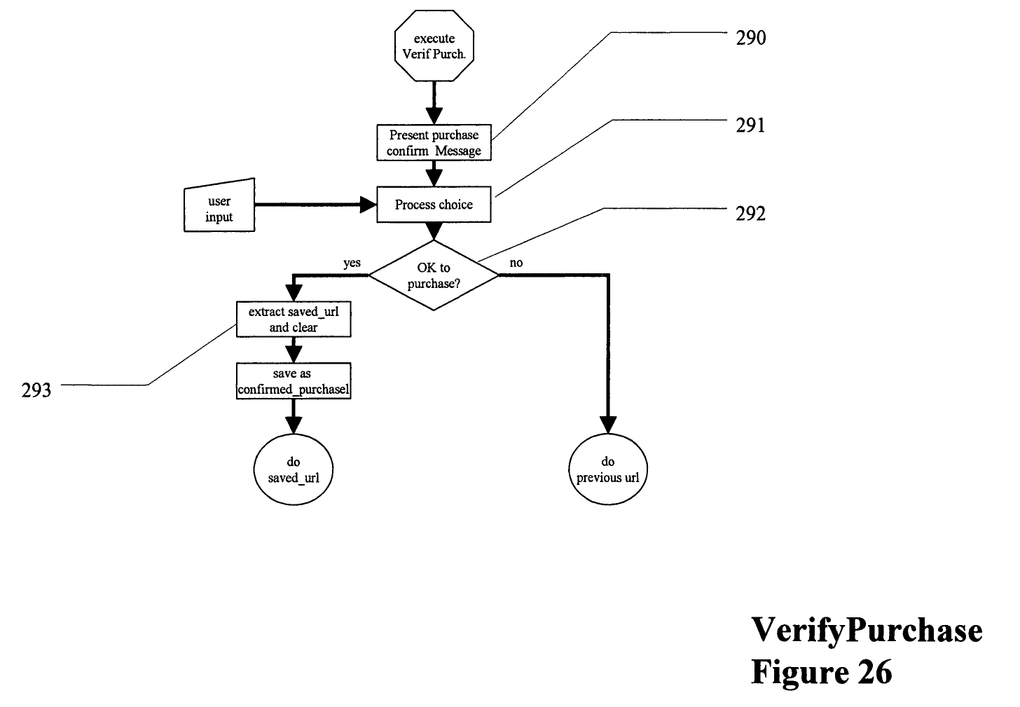

FIG. 26 describes the operation of the VerifyPurchase module. This module is triggered when a user has chosen to confirm each purchase. This module would normally be invoked from the actions associated with FIG. 13, block 170. The initial step is to inform the user of the purchase amount to be deducted from his (or, as appropriate, his group's) account balance, the status of his (or his group's) account, and his current accumulated purchase amount. The next step is to request the user to confirm (or approve) the transaction, as shown at block 290. The system then collects the user's choice, block 291, and checks the user's choice, block 292. If the user chooses not to proceed with the transaction, the system resubmits the request as a request for the previous URL. If the user has chosen to confirm the purchase, the system extracts the contents of the ‘saved_url’ (typically set by the actions in FIG. 11, block 156), clears that property, block 293, stores the URL in the ‘confirmed_purchase’ and resubmits a request for that URL.

In the preferred embodiment, accumulated charges displayed to the user (either in the confirmation notice, the confirmation threshold or by a direct user request) cover those charges incurred during the user's current session. It is recognized, however, that the charges may alternatively be accumulated on other bases, such as (a) those that are not yet paid for, (b) those that have been incurred since a specified date, and/or (c) those that have been incurred over a specified interval of time.

The behavior of the system at this point depends on the decision made in FIG. 13, block 169. In this case, the process recognizes that this purchase has been confirmed and proceeds with processing in FIG. 13, block 171.

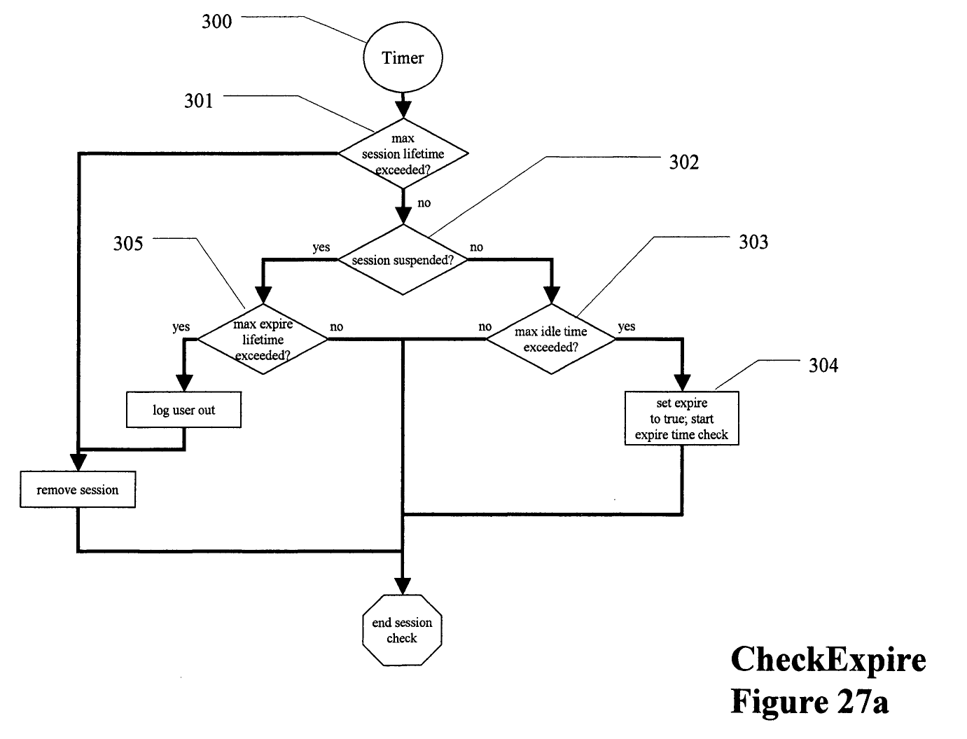

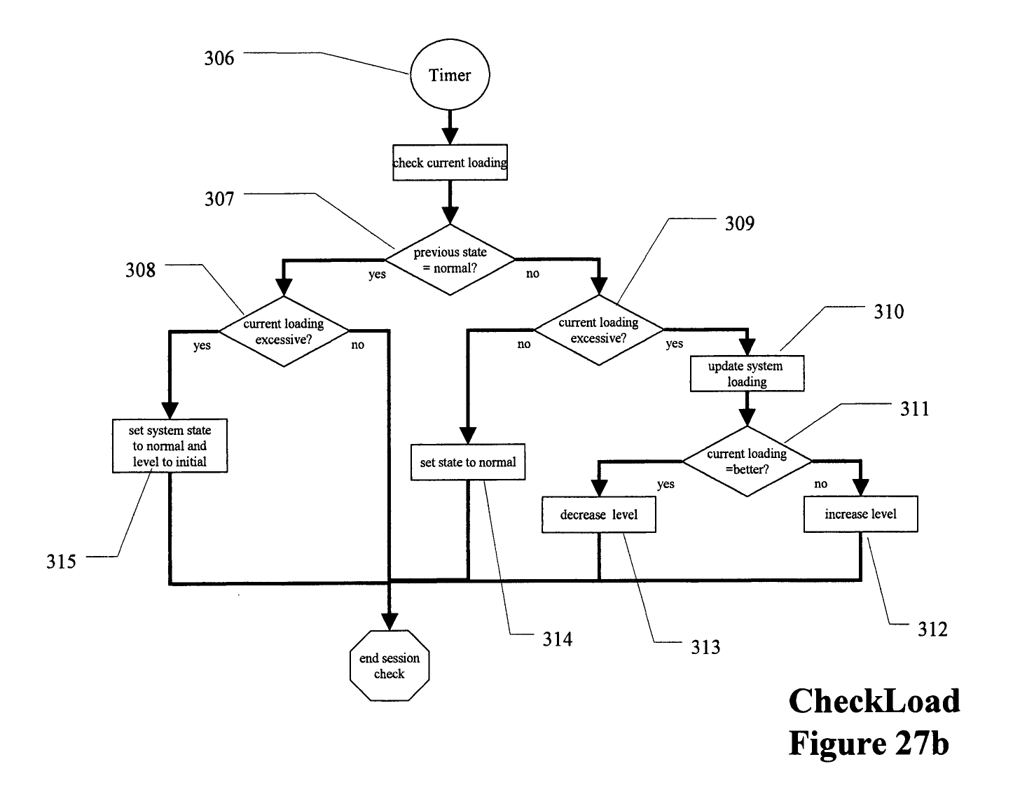

FIG. 27a shows the CheckExpire module, which deals with managing the sessions' lifetimes. Unlike the other modules so far discussed here, the CheckExpire module is activated by the system (rather than by a user's request). To understand how this works, it should be understood that there are several intervals of interest to the system. First, there is a maximum time that any session should be active, regardless of associated user's online activity—this is stored in the session object's ‘max_life’ property. Second, there is the maximum time that a logged in user may be inactive—this is stored as the session object's ‘max_idle’ property. The third interval is the maximum time that a session will be kept around in the suspended or ‘expired’ state (so a timed-out user may easily continue). This is stored in the session object's ‘max_expire’ property.

As described earlier, every time the user makes a request, the session object's ‘last_visited’ property's timestamp, previously referenced in block 77 of FIG. 6a, is updated. On a configurable periodic basis, the system timer 300 starts a thread of execution that handles the CheckExpire processing logic. First, the system checks all the sessions to determine if any have been in existence too long, block 301, in which case the session objects are removed.

Then the system checks if the session has been suspended, block 302. If not, the system checks to see if any active session has been idle long enough so it should be suspended, block 303. If so, the system sets that session's ‘expire’ property to true and resets the timer to start measuring the ‘max_expire’ property discussed in the next paragraph 304.

If the session has already been suspended, the system then checks if the session has been in the suspended state too long, block 305. This interval is stored in the session object's ‘max_expire’ property. If so, it will log the user out, and close out any pending financial/credit transactions. Then it will terminate and remove the session.

As is illustrated in FIG. 27b, a background process, illustrated starting at block 306, runs on a configurable periodic basis, determining then-current current system loading. Each time it checks the loading it also checks to see if an overload condition already exists, block 307. If so, and if the current loading is not excessive, block 309, the process sets the previous system loading state to ‘normal’, block 314. Otherwise, the process determines whether the current loading is the same as, worse than or better than the present state and updates the loading state with a value reflecting that result, block 310. If the current loading state is better than the previous loading state, the process will decrement the loading throttle level, block 313. If the current loading state is worse than the previous loading state, the process will increment the loading throttle level, block 312.

If the process determines that the loading state is ‘normal’ but that the current loading is excessive, block 308, it will set the loading state to ‘worse’ and set the loading throttle to its initial value, block 315.

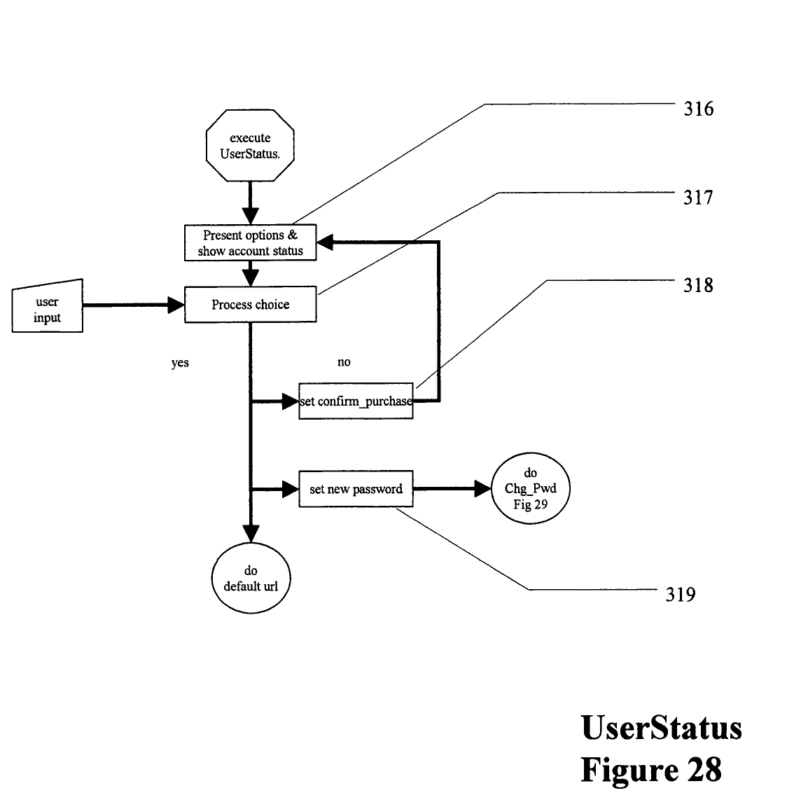

The UserStatus module, illustrated in FIG. 28, is typically invoked as a result of selecting an option presented by the default url, which is, as referenced earlier in FIG. 25, in the preferred embodiment, represented by the Welcome module. Initially this module presents the user's current account status and four options, block 316, and processes the user's choice, block 317. As shown at block 318, one of these options allows the user to change the ‘confirm_purchase’ flag, previously references in FIG. 13. If this is set to ‘false’, any charges will automatically be deducted from the user's (or, as appropriate, the user's group) account without any specific notice. If it is set to ‘true’, then, prior to each charge being applied, the user is presented with a verification choice. The system allows the user to also define and change a charge threshold, such that confirmation will be assumed for charge amounts less than this threshold. In addition, the user may also define and change a cumulative threshold, based on several alternatives, including the cumulative charges per session, and the user's (or group's) cumulative total obligations. With both cumulative and charge thresholds set, the confirmation request will only be issued if both thresholds have been equaled or exceeded.

Another option, shown at block 319, allows the user to change his/her password. If this option is selected, the user is requested to enter their current password and then enter the new password twice. Then the request is resubmitted as a ChgPwd request. The last option allows the user to return to the default url page (by resubmitting a default url request).

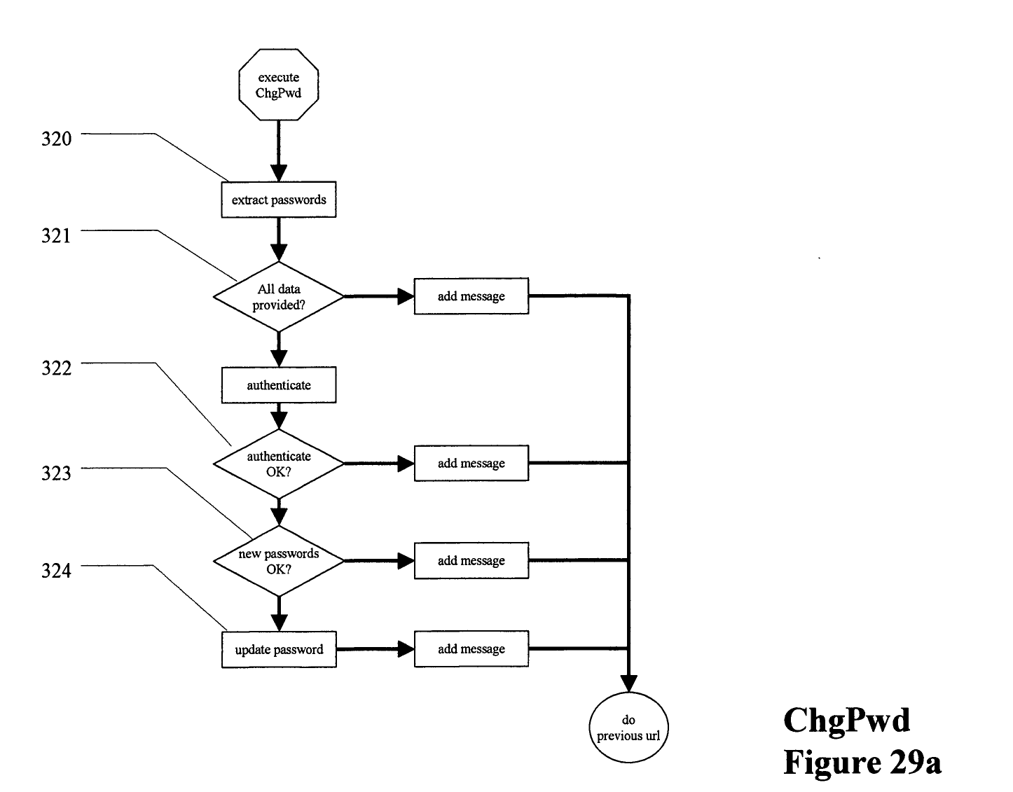

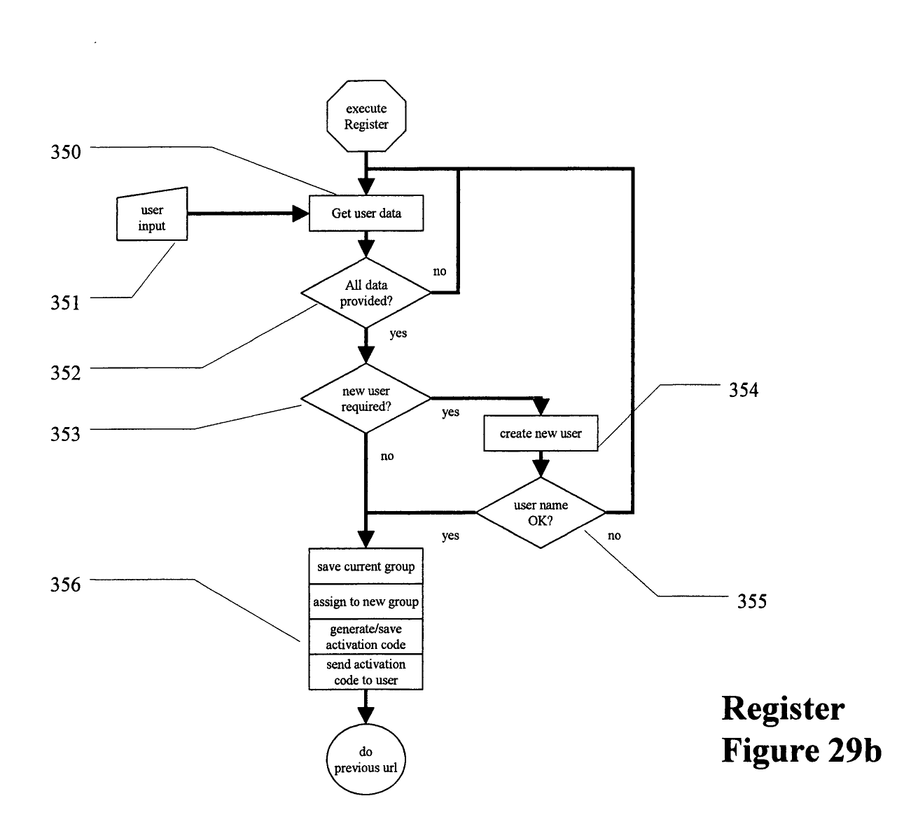

FIG. 29a shows the ChgPwd module, which is typically invoked as a result of selecting an option presented by the UserStatus Module, previously referenced in FIG. 28. First, the current and new passwords are extracted, block 320. If this succeeds, the system attempts to authenticate the user with the current password supplied by the user. If succeeds fails 322, the system checks to ensure that the two new passwords provided by the user (to help reduce the risk of a data entry error) are compared. As shown at block 323, if they match, the system changes the password and resubmits the request to the calling module (via the previous url), adding a confirmation message.

If any of the previous checks (represented by blocks 321, 322 or 323) fail, the request is resubmitted to the calling module (via the ‘previous_url’) along with an explanatory message.

FIG. 29b shows the Register module, which allows a user to change from its currently assigned subscription plan to another subscription plan. A set of configurable parameters define the available options; these include: (a) a subscription plan which a user may elect to join, (b) the subscription plan(s) to which a user currently must belong in order to make this particular change, (c) the information that is required to be provided by the requesting user to implement this change, (d) a time interval during which the requesting user may operate under the new plan before the new activation code must be entered, and (e) the mechanism to be used to communicate the activation code to the requesting subscriber (e-mail, regular mail, or telephone, depending on the information that needs to be verified to grant access to the associated subscription plan).

Initial processing begins with a determination of the plan for which the requesting user wishes to register which is provided by the user in making the original request, and verifying that the requesting user is authorized to make that registration change, as shown at block 350. If the user is not authorized to change to the requested plan, the requesting user is so informed and allowed to change the request.

Next, the user is prompted to enter and submit the additional required information, block 351. When the information is submitted, if it is incomplete, the user is requested to revise and resubmit the requested information, block 352.

Once the system verifies that all required information has been provided, if the requesting user is associated with a shared identity user object, block 353, the system will create a new user object, using the name and password provided by the requesting user, block 354. Since the name of the user object must be unique, it is possible that the name selected by the user may already be in use. If that is the case the system will so inform the requesting user and request a new name, block 355, repeating the process until the system is able to create the new user object.

The system will then (a) save that object's current group reference, (b) initialize the requesting user associated user object, (c) generate and save an activation code, and (d) communicate that activation code to the user through the appropriate communications mechanism (as discussed above, this may include an e-mail, a regular mail message, a telephone call, etc.).

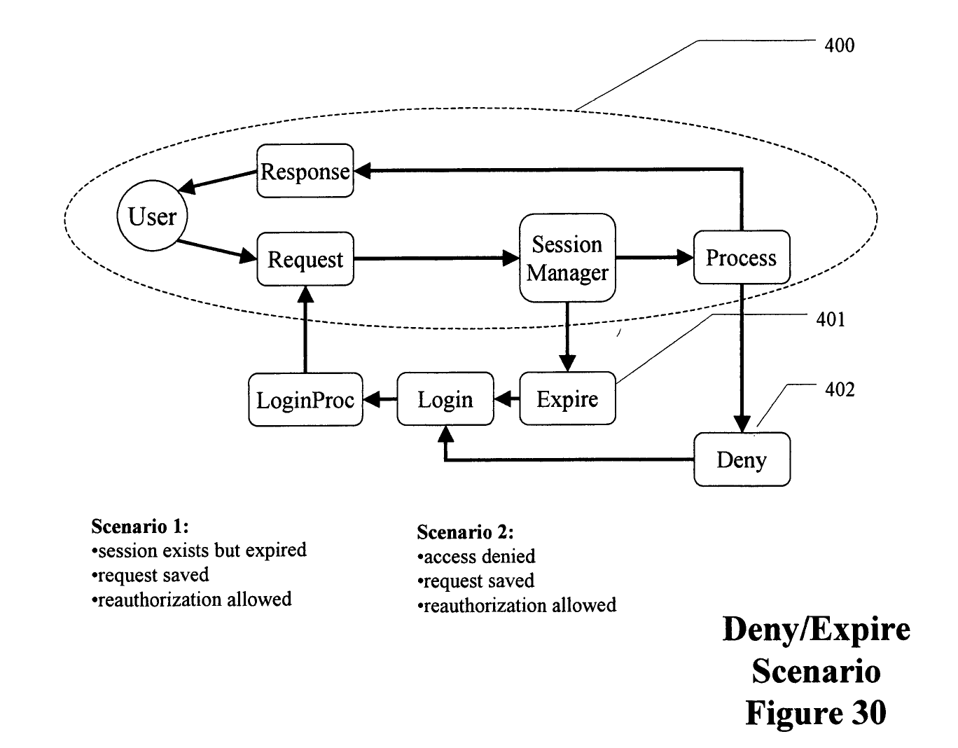

The processing logic described in FIGS. 6 through 29a is depicted at a higher level of detail through the scenarios shown in FIGS. 30 through 34. The first one, FIG. 30, illustrates the process by which a request is denied because of access restrictions, and a request that is denied because the user's session has timed out. The basic request-response process, block 400, is repeated in the other scenarios. This basic request is merely a summary of the process described earlier in FIGS. 6 through 16, wherein the user submits a request that is initially processed by the session manager, and then by other components, eventually—if successful—resulting in a response sent back to the user.

FIG. 30 shows such a scenario wherein the session manager determines that the user has been inactive so long that the request cannot be processed directly. Instead, as shown at block 401, the Expire sub process is invoked, which in turn triggers the Login module This in turn invokes the LoginProc module and then the LoginMessage module.

FIG. 30 also illustrates the process that happens when a user attempts to access a resource to which access has not been granted. In this case, as shown at block 402, the Deny sub process is invoked, which results in calling the Deny Access module, which then invokes the Login module, following the sequence just described. This allows a user who has initially been granted an anonymous identity (the system's default behavior) to, in effect, override the system's denial by supplying credentials for a user with the desired access (in which case, as described earlier, the same session will be continued to be maintained, now with the new identity, and the original request will be processed as if it had been submitted by a user with the new identity).

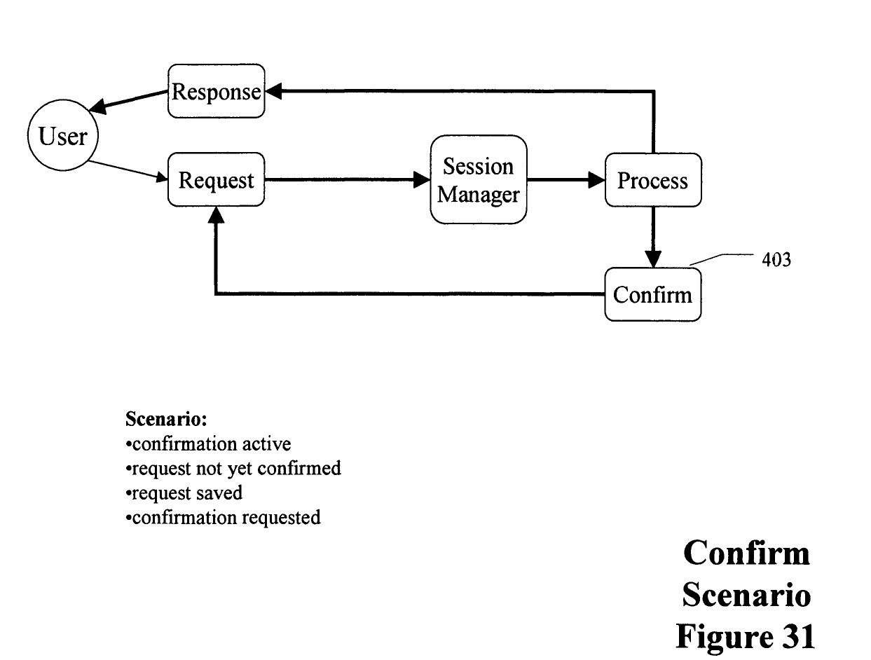

A scenario involving the confirmation is illustrated in FIG. 31. Using the same basic process just described in block 400 of FIG. 30, the user request is processed by the session manager and then handed off to subsequent processes. In this scenario, it is assumed that the user has elected to confirm the acceptance of each charge that may be associated with that user's requests. Thus the request is intercepted and routed to the confirm sub process, block 403. The details of how this process operates were previously references in FIG. 26, which describes the Verify Purchase module.

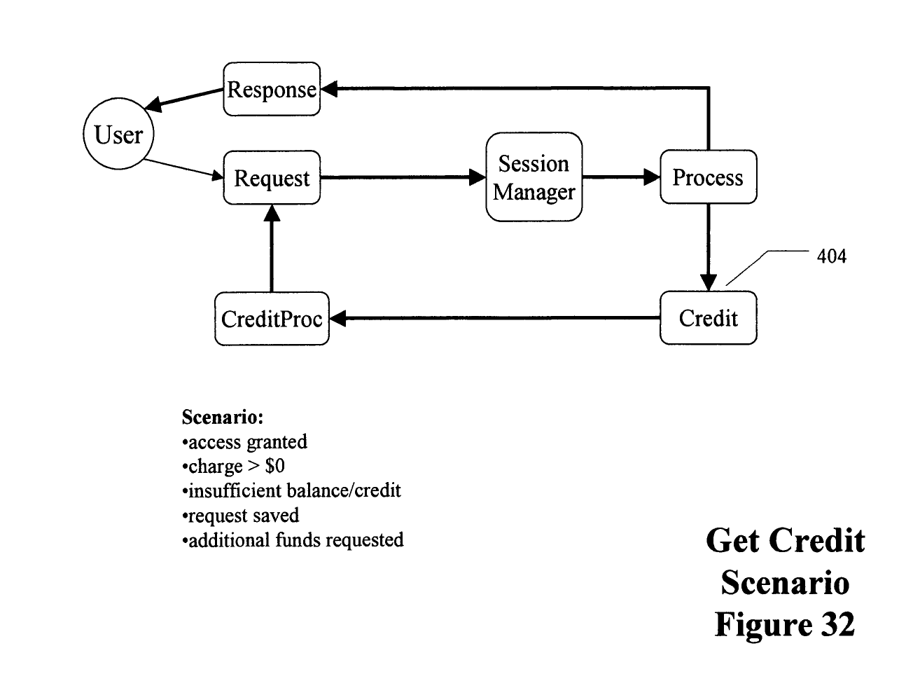

The scenario of when a user's request involves a charge that is greater than that user's financial situation allows, is depicted in FIG. 32. The user's request is intercepted and, after a determination is made that insufficient financial resources currently exist, the get credit sub process, block 404, is called to handle the request. Details on just how this is accomplished may be found in FIG. 23 (illustrating the GetCredit module), which in turn invokes the CreditProc module (described in FIG. 24).

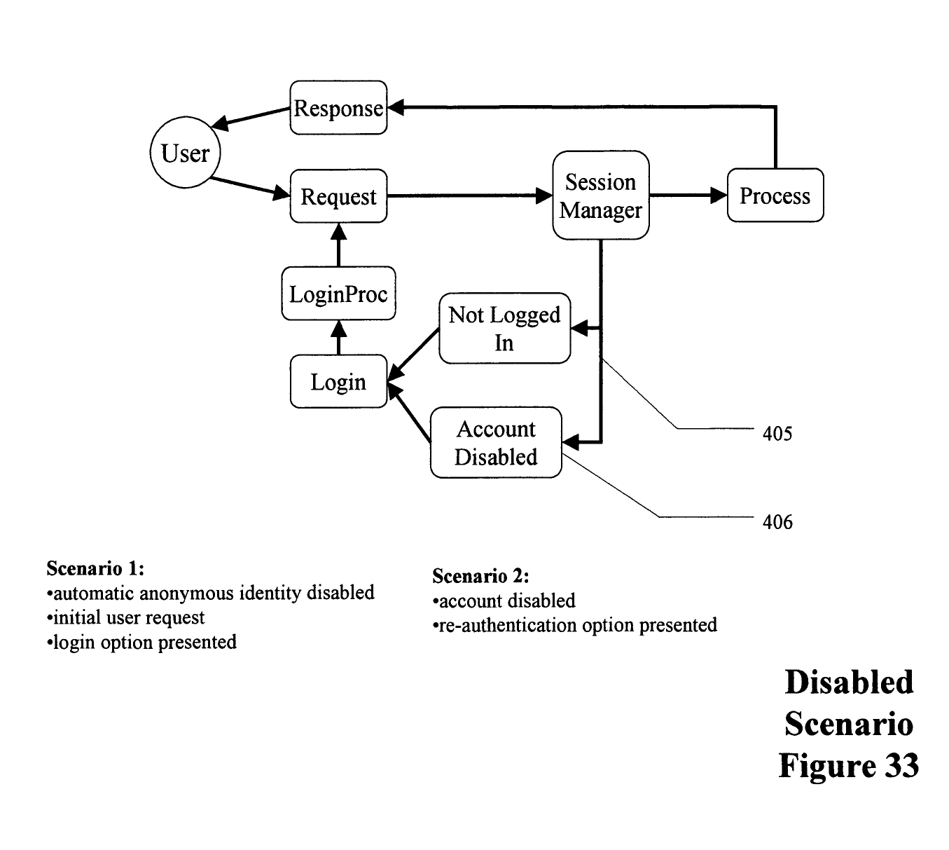

FIG. 33 illustrates the scenario in which a user whose account (either individually or via that user's associated group) has been disabled makes a request. In this case, it is the session manager that detects this condition and causes the account disabled sub process, block 406, to be invoked. This is illustrated in more detail in FIG. 22, which describes the operation of the Disabled module.

FIG. 33 also illustrates the scenario in which a user makes an initial request in a situation where the system has been configured not to automatically create an anonymous identity, which is the default behavior. In such a case, the session manager causes the not logged in sub process to be activated, block 405. This directly invokes the previously discussed Login module, whose described in FIG. 17.

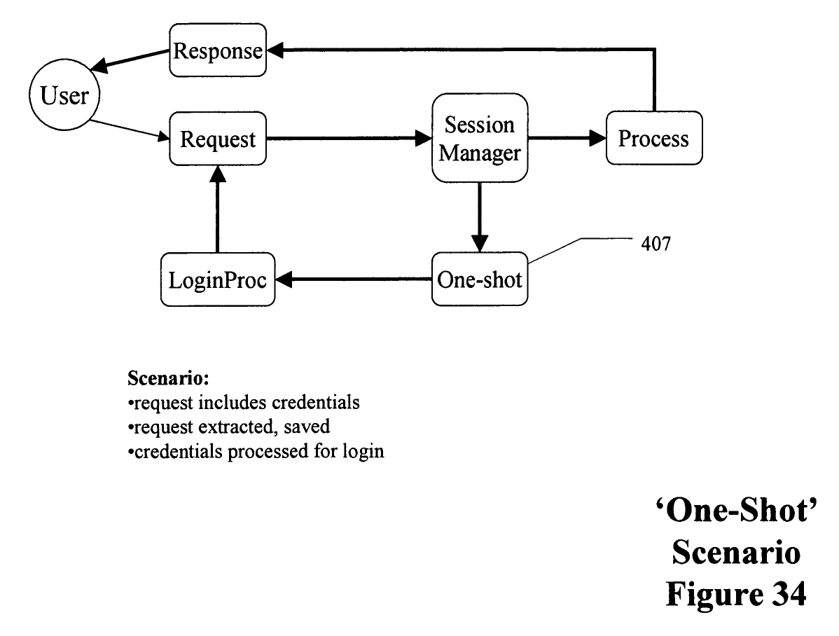

While the most common way of authentication is through use of the Login module, the system also supports a so-called ‘one-shot’ request, in which login credentials are included with the content request. As shown in FIG. 34, the session manager handles this situation by invoking the ‘one-shot’ sub process, block 407. As was described in more detail with reference to block 112 in FIG. 6b, this results in invoking the LoginProc module directly.

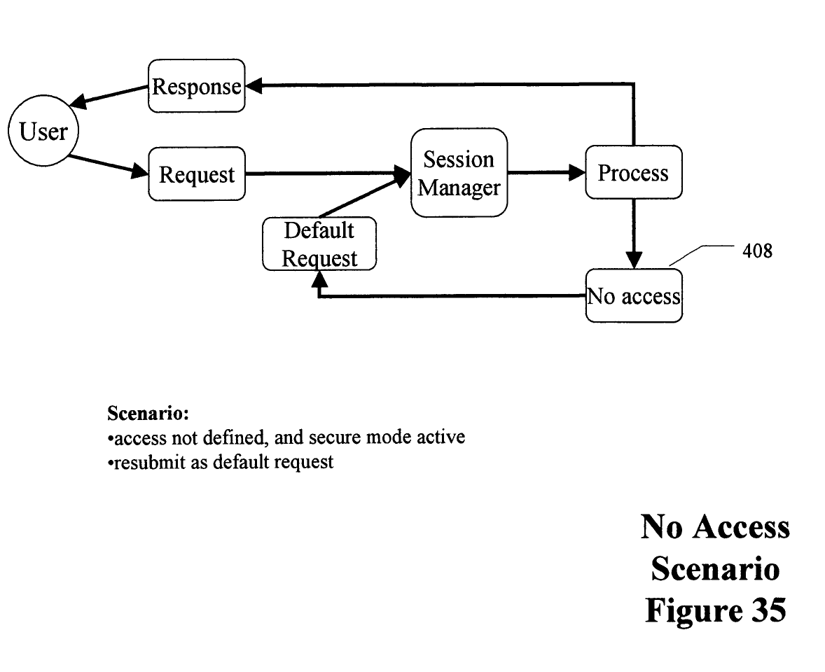

FIG. 35 describes the last scenario, which involves a user request for a resource that has not been made available to any user (other than the top administrative user). In this case, the system invokes the no access sub process, block 408. This was previously described in more details with reference to blocks 129 and 130 of FIG. 7, and blocks 134 and 135 of FIG. 8, both of which are routed to the processing logic described in FIG. 10.

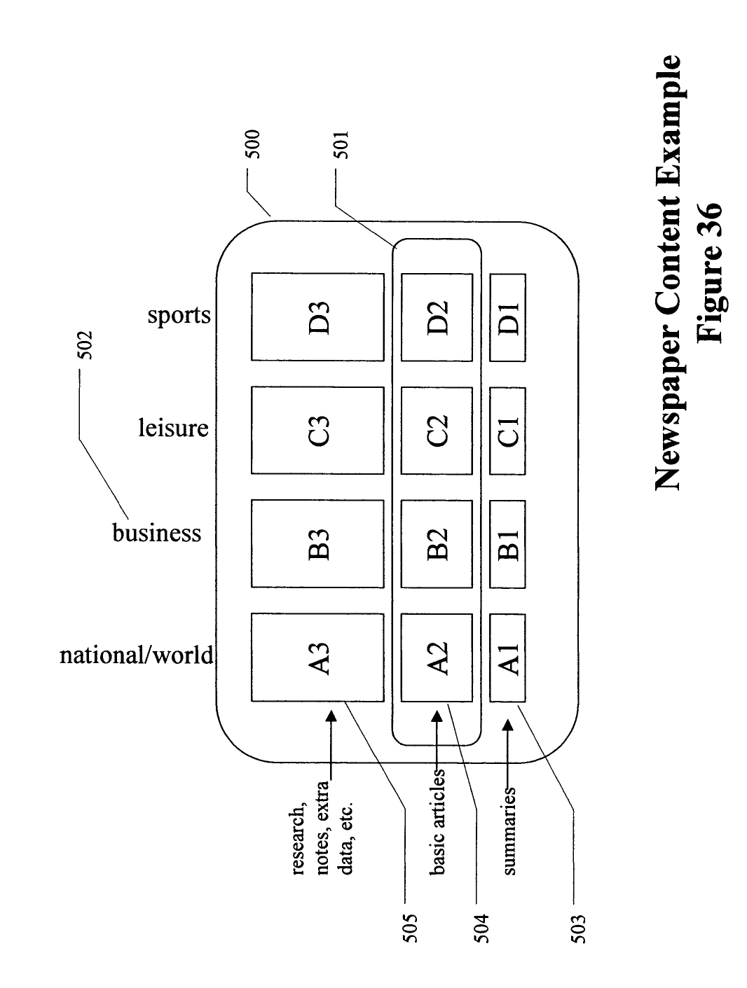

One of the major benefits of the system lies in how it can be used to help segment markets. To illustrate this we may consider a newspaper, the content of which may be diagrammed as in FIG. 36. In this example, we illustrate the content that is gathered in preparation for publishing the newspaper, block 500. Note that this content contains a number of topic areas 502. The four that are shown for illustrative purposes—national/world, business, leisure and sports—are coded with ‘A’, ‘B’ and ‘C’ plus the type.

As illustrated at block 501, the actual content that makes it into the newspaper itself is a subset of what is collected. It consists of summary information, block 503 and articles, block 504, relating to the four topic areas 502 just mentioned. Note that the newspaper does not include the extra information shown in block 505.

In this example, the objective is to create a set of information products that can be more closely tailored in composition and price to various ‘slices’ of the overall market. The benefit of doing this is that it allows information to be targeted to those individuals who value it more because it is specific to their needs.

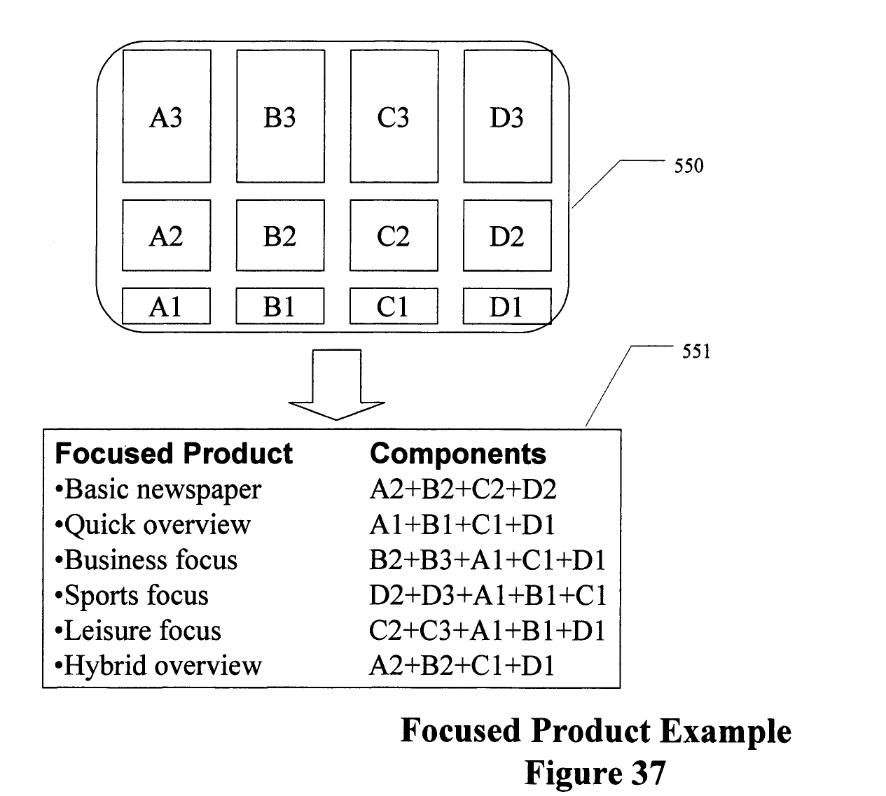

The type of products that might come out of such an exercise is illustrated in FIG. 37. In this figure, the overall content base 550 is identical to that previously referenced in block 500 of FIG. 36. What the publisher can now do is break this content base into its individual components (represented by the boxes with identifiers like ‘A1’, ‘B2’ and so forth). These components can then be combined with each other around the needs of specialized groups.

The ‘basic newspaper’, shown at block 551, is composed of the same elements as the newspaper shown in block 501, FIG. 36. However, in addition, other products are shown, block 551, that have a narrower readership focus. One (‘Quick overview’) is geared for readers who want only a quick summary. Another (‘Business focus’) might be designed to appeal to business-oriented readers. Same for the “Sports focus” and the “Leisure focus” products also described. Finally, there is a ‘Hybrid overview’ product that gives both summaries and articles pertaining to general and business news.

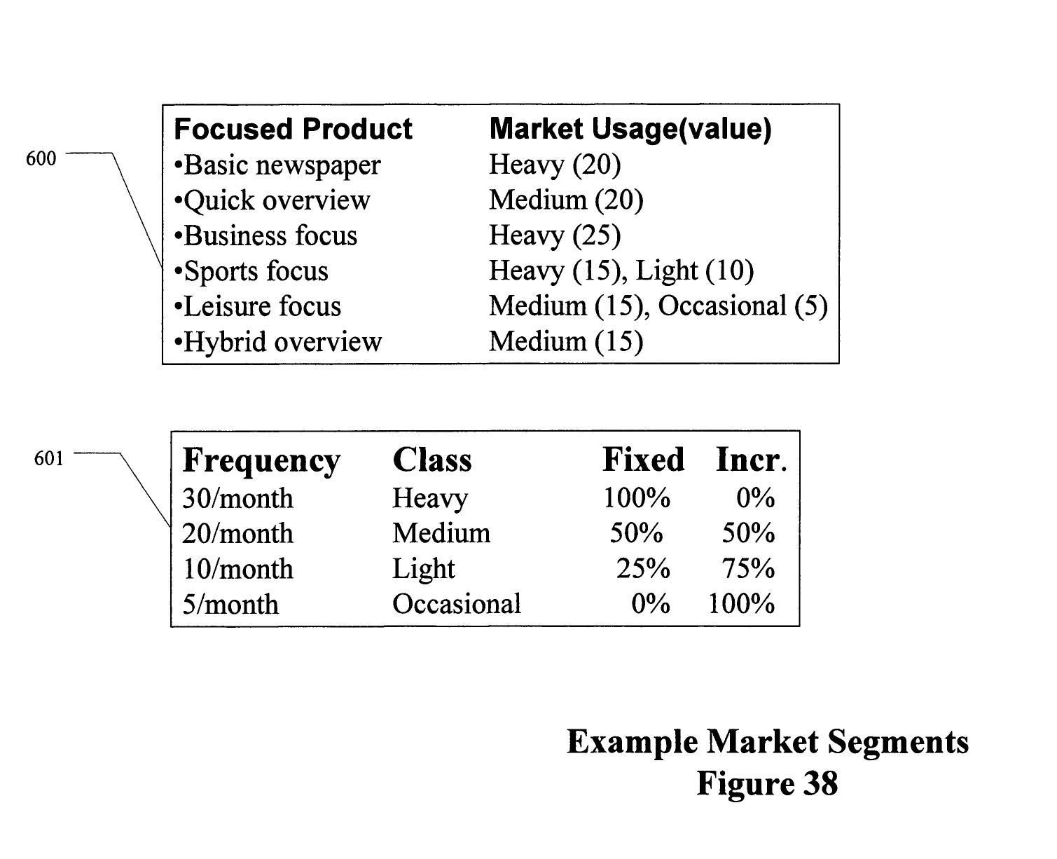

With further market research a publisher might be able to examine the market segments to which each of these new products is targeted to determine other characteristics. FIG. 38 shows the results that might come from such a hypothetical market analysis. This shows that, for example, the anticipated readership of the ‘Business focus’ publication would be heavy readers and would be willing to pay, say, $25 a month for the privilege 600. On the other hand, readers of the ‘Sports focus’ publication really fall into two groups, heavy readers who value it at $15/month and light readers who feel it is worth $10/month. These objectives could be quantified into various combinations of fixed and variable costs, block 601.

The Web-Exec™ system is designed to allow a publisher to not only create subscription plans that reflect this kind of fine-tuned content selection, but to also adjust prices with an equal or even better precision. Thus each market segment can be provided with exactly what they value the most at exactly a price they are willing to pay.

As stated above, although the preferred embodiment as described herein is applied to online information content, the concept and features of the invention are applicable in generally to any system delivering services of any type.

While the invention has been particularly shown and described with reference to particular embodiments thereof it will be understood by those skilled in the art that various changes in form and detail may be made therein without departing from the spirit and scope of the invention.

What is claimed is:

1. A system for electronically delivering information content to requesting clients for selected charges, said system serving clients having an associated balance equaling the real time accumulated charges imposed on each said client for delivery of said requested content, said system comprising in combination,
a) a plurality of plans, each one of said plans comprising
i) a plurality of accessible content elements, each one of said accessible content elements comprising downloadable content elements,
ii) a specific charge being imposed on said clients for obtaining selected accessible content elements;
b) a plurality authorized identities, each one of said authorized identities being associated with one of said plans,
c) authentication means for associating one of said clients with one of said authorized identities, a client associated with an authorized identity being permitted access to the accessible content elements defined by the plan with which said authorized identity is associated;
d) access control means for determining, prior to delivery of said content, whether said a requesting client is authorized access to said requested content, wherein the access authority of any one of said clients may be different from the access authority of a different client;
e) real time charging means for determining, prior to delivery of said content, the amount of any charge that may apply for the delivery of said content to said client wherein, for any specific instances of said content, said charge may be different for different clients;
f) localized delivery means for providing requested content to requesting clients wherein the system maintains full control of delivery of information content to the network at all times; and
g) real time reconciliation means for adding the amount of any said charge to said requesting client's associated accumulated charge balance at the time of delivery of said content to said requesting client, and wherein said charge is not added in the event that delivery of the content is not made,
whereby content is organized and priced to the needs of specific market segments, and said content is offered to multiple of such segments simultaneously, such that the charges for said content are processed with speed and with a minimum interruption to clients.

2. The system of claim 1 wherein each said charge has an interval component, a usage component, or both, wherein the value of said components may be zero, and wherein said interval component may include a plurality of relationships between an interval of time and an amount,
whereby charges may be defined in precise terms for each said plan.

3. The system of claim 1 wherein each one of said authorized identities is associated with a group comprising
a) an associated plan;
b) a discount, wherein any charge associated with said plan is multiplied by said discount and applied to user identities associated with said group;
c) an interval charge, wherein said interval charge is applied to user identities associated with said group,
whereby each said group simplifies the association with large numbers of user identities with a set of offered plans.

4. The system of claim 1 wherein each said client further has an available resource balance reflecting the resources available to said client for paying charges imposed by said system, said system further comprising
a) real time comparing means for determining if the amount of said available resource balance is sufficient to pay any charge computed by said real time charging means;
b) and wherein a real time reconciliation means further adjusts said available resource balance to reflect payment of any said computed charge,
whereby said system is able to determine each client's ability to pay charges and condition delivery of requested information content elements on said determination.

5. The system of claim 4 wherein each of said accessible content element further includes an associated usage credit amount, and wherein each of said plans further includes a credit allowance flag, wherein if said credit allowance flag of the plan associated with said requesting client is defined as true, said requesting client's associated available resource balance will be adjusted to reflect the deposit of any said usage credit amount associated with said requested information content element, whereby said system may be used to create financial incentives to users for requesting specified information content elements, as well as imposing costs.

6. The system of claim 4 wherein each of said plans further includes an initial amount, wherein said amount is periodically added to the available resource balance of each client associated with said plan,
whereby each plan may offer a specified number of said information content elements to subscribers at no additional charge, since their payment will be covered by the periodic deposit of the initial amount to each user's available resource balance.

7. The system of claim 4 wherein said available resource balance amount is equal to the total of additions minus imposed charges,
whereby the amount available to a client is determined by the cumulative amount of unpaid charges and an amount pre-paid by the client, providing flexibility to adjust the credit depending on the financial risk associated with said client.

8. The system of claim 4 wherein each of said requesting clients further includes a credit limit amount and wherein said available resource balance amount is equal to said credit limit minus the total of imposed charges minus additions,
whereby the amount available to a client is determined by the cumulative amount of unpaid charges and a specified credit limit, providing flexibility to adjust the credit depending on the financial risk associated with said client.

9. The system of claim 4 wherein each of said requesting clients further includes a debit balance, a credit balance and a credit limit, wherein said debit account balance equals the total deposits made to said debit balance minus the total withdrawals made from said debit balance plus said credit limit minus the amount of said credit balance, wherein the available amount of said balance being equal to the amount of the debit balance plus the credit limit minus the credit balance, and wherein said real time reconciliation means adjusting the amount of said account by first reducing the debit balance and next, if necessary, increasing the credit balance,
whereby content providers can tailor each client's account to the proper mix of pre-payment requirements and extended credit.

10. The system of claim 5 wherein each one of said plans includes a discount that can be of a fixed amount, an amount dependent upon a cumulative measurement of usage, or a combination of the two,
whereby each plan may be more easily reused by multiple groups, and each user associated with a specified plan may be given an incentive to consume additional resources in return for an increased overall discount on imposed charges.

11. A system for electronically delivering information content to requesting clients, wherein said system may impose a charge for delivering said content, and wherein the identity of said clients is known to said system, said system comprising
a) one or more accounts, each one of said accounts holding an amount equal to the funds available for the payment of charges by authorized clients, wherein one or more of said authorized clients has the ability to withdraw funds from one of said accounts to pay for charges imposed for requested and delivered content, and wherein each one of said accounts may restrict the total of funds withdrawn by one of said authorized clients;
b) charge-computing means for determining, prior to delivery of said content, the amount of any pending charge wherein said charge applies to the delivery of said content to said client wherein, for any specific instances of said content, said charge may be different from the charge imposed on a different client;
c) payment means for ensuring, prior to delivery of said contents, that the available amount of a client's associated account is greater than or equal to any pending charge, and that the amount of any pending charge when added to the accumulation of charges previously imposed on said client is less than any said withdrawal restriction on said account applying to said client;
d) delivery means for providing requested content to requesting clients; and
e) reconciliation means for adjusting said the amount of said account to reflect the payment of any charge imposed on said client for delivery of said content to said requesting client,
whereby charges imposed by delivery of content to selected requesting clients may be paid for by a single collective account such that the party responsible for funding said collective account is protected from excess charges incurred by any specific requesting client.

12. The system of claim 11 wherein the amount of each of said accounts equals the total deposits made to said balance minus the total withdrawals made by said authorized clients from said balance, and wherein said reconciliation means adjusting the amount of said account by deducting any imposed charges from said account.

13. The system of claim 11 wherein each of said accounts also includes a credit limit, wherein said account amount equals the amount of said credit limit minus the total deposits plus the total withdrawals made by said authorized clients from said balance, and wherein said reconciliation means adjusts the amount of said account by deducting any imposed charges from said account,
whereby content providers can construct organizational accounts that extend credit based on the credit risk of each organization with respect to each specific content provider.

14. The system of claim 11 wherein each of said accounts comprises a debit balance, a credit balance and a credit limit, wherein said account balance equals the total deposits made to said debit balance minus the total withdrawals made from said debit balance plus said credit limit minus the amount of said credit balance, wherein the available amount of said balance being equal to the amount of the debit balance plus the credit limit minus the credit balance, and wherein said reconciliation means adjusts the amount of said account by first reducing the debit balance and next, if necessary, increasing the credit balance, whereby content providers can construct organizational accounts that reflect a mixture of pre-payment and extended credit based on the credit risk of each organization with respect to each specific content provider.

15. In a system for electronically delivering information content to requesting clients, wherein said system imposes a charge for delivering said content to said requesting clients, each requesting client has a temporary account wherein the initial balance of said account being is to zero, and each requesting client has a remote account wherein said client may conduct financial transactions with said remote account through specified payment vendors, a method comprising
a) prior to delivering said requested account, computing the charge that applies to a requesting client for requested content;
b) determining if the amount of said temporary account balance is equal to or greater than computed pending charge;
c) if said pending charge is less than said temporary account balance, deducting the amount of said pending charge from the amount of said temporary account balance;
d) if said charge exceeds the amount of said temporary account balance, presenting said client with the opportunity to enter a payment request and if said request is entered, forwarding said payment request to an appropriate payment vendor, and if said payment vendor provides funds, depositing said funds into said client's temporary account, and if said temporary balance including said deposited funds exceed or equal the amount of the pending charge, deducting the amount of said pending charge from the amount of said temporary account balance;
e) if said client elects to close said client's temporary account, transferring any excess of funds in said temporary account balance to said client's remote account; and,
f) if said client ceases to produce requests for content for a specified period of time, closing said client's temporary account, transferring any excess funds in said temporary account balance to said user's remote account,
whereby clients who have not registered with a content provider may be encouraged to purchase with greater frequency than they otherwise would, and whereby content providers may conduct transactions with such clients in a manner that reduces the transaction charges that would normally be incurred when non-registered clients are involved.

16. In a system for electronically delivering information content elements to requesting clients, wherein different clients have access to different sets of information content elements, a method comprising
a) upon receiving a client's initial request, establishing a session and associating an anonymous user identity with said session;
b) ensuring that each subsequent client request is uniquely associated with a session;
c) allowing access to information content elements to clients with proper access rights;
d) if a requesting client does not have proper access rights;
i) denying access to information content elements by said client,
ii) prompting said client to enter authentication credentials,
iii) authenticating said client, and,
iv) if said authentication is successful, associating said client's existing session with said new identity, and continuing to process said client's request for said information content element,
whereby visitors are not required to login to obtain access, users may easily create and use browser bookmarks to obtain content, and multiple identities may be employed to minimize unnecessary exposure of content to unauthorized access.

17. A method for enabling an online system to serve information content to requesting clients, comprising the steps
a) receiving a request for said information content from a client;
b) determining if the delivery of an item of information content will result in a charge being imposed on said client;
c) if said charge is greater than zero, prior to delivering said information content to said client, presenting to said client a notice describing the amount of said pending charge and, optionally, the cumulative total of said client's purchases and said client's current charge balance;
d) enabling said client to choose whether or not to proceed with the delivery of said item of information content and imposing said charge;
e) permitting said client to terminate said request for said item of content; and
f) enabling said client to elect to have such a notice and choice to cancel delivery of said content for each request and enabling said client to elect not to have said notice and choice presented for each request,
whereby clients who are concerned about the accumulation of large charges may exercise direct control of said charges, while other clients may forego said control to achieve more streamlined operation.

18. A method as in claim 17 further including the step of determining whether or not to have said notice and choice presented based on whether said charge exceeds a threshold value, said threshold value being definable and changeable by said requesting user,
whereby clients who are concerned about the accumulation of large charge amounts may exercise a balance between notification and streamlined operation by their choice of a notification threshold based on the amount of any pending charge.

19. A method as in claim 17 further including the step of determining whether or not to have said notice and choice presented based on whether the amount of said client's accrued charges exceeds a threshold value, said threshold value being definable and changeable by said client,
whereby clients who are concerned about the accumulation of large charge amounts may exercise a balance between notification and streamlined operation by their choice of a notification threshold based on the amount of accumulated charges.

20. In an online system for providing services to requesting clients, said system establishing and maintaining a session for each requesting client, said session being suspended after an initial period of inactivity by said requesting client, and said session being terminated after a subsequent additional period of inactivity by said requesting client, a method comprising
a) receiving a request from a client whose session is suspended
i) prompting said client for credentials to authenticate;
ii) authenticating said credentials; and,
iii) if the authentication is successful, restoring said client's suspended session to active status and continuing to process said request;
b) receiving a request from a client whose session has been terminated
i) prompting said client for credentials to authenticate;
ii) authenticating said credentials; and,
iii) if authentication is successful, creating a new session and continuing to process said request;
c) receiving a request from said client which has no associated session
i) creating a new session;
ii) associating said request with a default (anonymous) user identity and continuing to process said request (and alternatively, prompting the client for credentials and requiring a login),
whereby said system can improve security by minimizing the time that an inactive connection is accessible yet still providing clients whose session has timed-out with the capability to quickly and easily resume their session activity.

21. In an online system for delivering information content elements to requesting clients, said system providing multiple subscription plans, and said users being authenticated in order to access said content elements, a method comprising,
a) presenting said client with the option to register for one of a selected set of subscription plans that are different from the subscription plan with which the client is currently associated;
b) receiving said client's registration information and determining said client's suitability to become a subscriber of the requested new subscription plan, wherein the criteria for subscription suitability differs for different subscription plans;
c) upon determining the client is suitable for subscribing the requested subscription plan, generating a unique activation code and associating that with said client, and changing said client to new plan;
d) communicating said activation code to said client in a manner verifying specified elements of said client's registration information, wherein said elements to be verified and the means for conducting said communication being specific to the requirements of the new subscription plan;
e) processing client's authentication requests wherein the password provided by said client fails to authenticate, determining if said password matches said associated authentication code;
f) if said password matches said associated authentication code, changing said user's plan permanently to the selected plan; and,
g) if said client's password fails to match the stored credentials, and said password fails to match said activation code, or if said activation expiration date has been exceeded, reverting user back to previous plan,
whereby content providers may offer incentives that encourage clients to shift their subscription to plans providing more revenue to said content provider.

22. In a system for electronically providing services to requesting clients, a method comprising
a) detecting the onset of load conditions;
b) selectively adding specified delays to the processing of requests for different categories of requesting clients;
c) detecting when overload conditions are reduced; and,
d) selectively removing added processing delays,
whereby said system may continue to provide responsive service to higher priority during times of heavy network congestion, including congestion caused by denial of service attacks.

23. In a system for electronically providing services to requesting clients, said system maintaining a plurality of user accounts, each of said accounts containing unique identification credentials, a method comprising,
a) prior to delivering said services, ensuring that requesting client is authenticated, said authenticated client being identified with a specific user account;
b) upon receiving a request from a requesting client that has not been authenticated, requesting authentication credentials from said client;
c) if requested authentication credentials are provided by said requesting client, attempting to authenticate said new requesting client against an account, wherein said credentials provided by said requesting client match the unique identification credentials associated with one of said accounts;
d) if said account that contains credentials matching the credentials provided by said requesting client, prohibits concurrent use of said account, and if another client has been authenticated against said same account and is currently using said system, denying said requesting client access to said system; and,
e) as may be specified by said system, applying additional actions comprising,
i) imposing a fee on said account;
ii) changing the password of said account and informing said requesting client of the new password; and,
iii) disabling said user account, wherein subsequent authentications will be rejected,
whereby clients who improperly share an account will be detected and discouraged from continuing said sharing because the cost of imposed charges, the difficulty of keeping track of system-generated password changes, or the loss of access due to the account being disabled.

24. In a system for electronically delivering information content to requesting clients, said system comprising a plurality of plans, each ones of said plans comprising a plurality of accessible content elements, said accessible content elements comprising downloadable elements; said clients each having access to an associated charge balance; and a plurality of authorized identities, each of one of said authorized identities being associated with one of said plans, said method comprising
a) linking a requesting client with one of said authorized identities;
b) permitting a client associated with an authorized identity access to the accessible content elements defined by the plan with which said authorized identity is associated;
c) limiting access of said requesting clients to content to which said client has been granted access, wherein the access granted to any one of said clients may be different from the access granted to a different client;
d) computing, prior to delivery of said content, the amount of any charge that may apply for the delivery of said content to said client wherein, for any specific instances of said content, said charge may be different from the charge imposed on a different client;
e) delivering the requested content to requesting clients; and
f) if delivery is completed successfully, adding the amount of any said charge to said requesting client's associated accumulated charge balance at the time of delivery of said content to said requesting client,
whereby content is organized and priced to the needs of specific market segments, and said content offered to multiple of such segments simultaneously, and the charges for said content are processed with speed and with a minimum interruption to clients.

25. A system for electronically delivering information content to requesting clients, the system comprising
a) a plurality of plans, each of which plans comprises
i) a plurality of accessible content elements, each of which accessible content elements is a downloadable content element or plurality of downloadable content elements;
ii) a charge that is imposed for obtaining selected accessible content elements;
b) authorized identities, each of which authorized identity is associated with a said plan, wherein each said client associated with one of said authorized identities is granted access to the accessible content elements defined by the plan with which said authorized identity is associated;
c) processing means for delivering content to requesting clients based on the access rights and charges specified by the plan associated with said client's associated authorized identity;
d) post-processing means for ensuring that, after delivery of said information content is attempted, charges are not applied for content that is not properly delivered as when a transmission error occurs;
e) chaining means for causing a new request to be processed by the system without further communications with the requesting client, wherein said new request is issued after the original request has been processed.

26. A system for electronically delivering information content to requesting clients, wherein
a) said system comprises a single server computer; and
b) said system may be hosted on a shared computer provided by a third-party web hosting vendor under a shared web-hosting service offering, wherein said system requires no proprietary server connections other than those provided under typical shared web hosting service;
and the system comprising
c) a plurality of plans, each of which plans comprises
i) a plurality of accessible content elements, each of which accessible content elements is a downloadable content element or plurality of downloadable content elements;
ii) a charge that is imposed for obtaining selected accessible content elements;
d) authorized identities, each of which authorized identities is associated with a plan, wherein each said client associated with said authorized identity is granted access to the accessible content elements defined by the plan with which said authorized identity is associated; and,
e) processing means for delivering content to requesting clients based on the access rights and charges specified by the plan associated with said client's associated authorized identity.

27. A client-server system including a server that electronically provides services to requesting clients, wherein each one of said clients has access to an account balance specified for use in paying charges associated with delivery of said requested service, said server comprises
access control means for determining, prior to delivery of said service, whether said clients are authorized access, wherein the access authority of any one of said clients may be different from the access authority of a different client;
charging means for determining, prior to delivery of said service, the amount of any charge that may apply for the delivery of said service to said client wherein, for any specific instances of said service, said charge may be different from the charge imposed on a different client;
payment means for determining, prior to delivery of said service, if said requesting client's account balance is sufficient to cover any said charge;
delivery means for providing requested service to requesting clients; and,
reconciliation means for deducting any said charge from said requesting client's account balance at the time of delivery of said service to said requesting client.

28. A method for electronically providing services from a server to requesting clients comprising
a) providing an accessible account balance for each of said clients, which account balance is useable for paying charges associated with delivery of said requested service;
b) determining if a requesting client has been authorized to access said requested service, wherein the access authority of any one of said clients may be different from the access authority of a different client;
c) computing any charge that may be imposed to deliver said service to said requesting client wherein, for any specific instances of said service, said charge may be different from the charge imposed on a different client;
d) determining if said client's account balance is sufficient to cover any said charge;
e) delivering said requested service to said requesting client;
f) adjusting said client's account balance to reflect any said computed charge.

29. A system for delivering information content elements to clients of the system requesting selected content elements, said system utilizing an internal data structure to define the access rights of said clients and the charges to impose upon said clients, said internal data structure comprising
a) a multiplicity of information content objects,
b) a plurality of user data objects, each one of which user data objects being linked to a single group data object;
c) a plurality of group data objects, each one of said group objects being linked to a single plan data object;
d) a plurality of resource data objects, each one of said resource data objects including a price and each one of said resource data objects being linked to a plan data object and to one or more information content objects;
e) said system interpreting said relationships between said data objects such that all user data objects linked to the same group data object have access to the same information content elements, and all information content elements accessible to user data objects linked to a single group data object having the same price;
f) said system associating each one of said requesting clients with a specific one of said user data objects;
g) said system granting said clients access to accessible content elements via links between
i) said user data object, said group data object to which said user object is linked;
ii) said plan object to which said group data object is linked, said resource data object linked to said plan data object; and
iii) said content element linked to said resource data object; and,
h) wherein said system imposes charges on said requesting clients as defined by the effective prices in the link provided by the system to the requesting client.

30. A content merchandizing system for electronically delivering content to requesting clients, said system including a plurality of subscription plans each having accessible information content elements and a charge, said system controlling access and imposing charges based on the subscription plan with which said requesting client is associated, said system further including remote retrieval means for selectively obtaining said content requested by said requesting client from a different online system, said remote retrieval means performing as a client in requesting content from said different system, whereby said system provides subscription plan-based access control and pricing for some or all content served by said different online system, without interfering with said different system's operation, or duplicating its data sources.

31. The system of claim 30 wherein said system further includes request translation means for translating requested content into requests for content from said different system
whereby said system's interaction with said different system may be made completely transparent to said system's requesting clients.

32. The system of claim 30 wherein said system further includes local retrieval means for obtaining requested content from content sources residing on, accessible from, or generated by, said system,
whereby said system serves requesting clients with requested content that consists of an integration of locally and remotely retrieved content.

33. A system for electronically providing services to requesting authenticated clients, said system comprising,
a) local authentication means for verifying the identities of said clients directly by matching of credentials supplied by said client with those held by said system,
b) one or more external authenticating means supported by such system for verifying the identities of said clients by means external to said system,
c) said system maintaining access, formatting and processing means specific to each one of said external authentication means,
d) authentication selection means for providing clients with the option of using said local authentication means or external authentication means,
whereby any of said clients may gain access to said system services through said local authentication means or through an external means depending on a client's requirements or the availability of an external means.
